(19) United States
(12) Patent Application Publication
(10) Pub. No.: US 2024/0314385 A1
(43) Pub. Date: Sep. 19, 2024

(54) MEDIA PROCESSING APPARATUS, MEDIA PROCESSING METHOD, AND MEDIA PROCESSING PROGRAM

(71) Applicant: NIPPON TELEGRAPH AND TELEPHONE CORPORATION, Tokyo (JP)

(72) Inventors: Maiko IMOTO, Musashino-shi, Tokyo (JP); Shinji FUKATSU, Musashino-shi, Tokyo (JP); Hiromu MIYASHITA, Musashino-shi, Tokyo (JP)

(73) Assignee: NIPPON TELEGRAPH AND TELEPHONE CORPORATION, Tokyo (JP)

(21) Appl. No.: 18/576,108

(22) PCT Filed: Jul. 7, 2021
(86) PCT No.: PCT/JP2021/025655

§ 371 Date: Jan. 3, 2024

(51) Int. Cl. H04N 21/43; H04N 21/238

(52) U.S. Cl. CPC H04N 21/43072; H04N 21/23805

(57) ABSTRACT

In an embodiment, a medium processing device is a device of a first base, including a reception unit that receives a packet that stores a second medium acquired in a second base at a time at which a first medium acquired at a first time in the first base is reproduced in the second base, and a processing unit that generates a third medium from the second medium according to a processing mode based on a second time associated with reception of a packet that stores the second medium and the first time, and outputs the third medium to a presentation device.

### TECHNICAL FIELD

One aspect of the present invention relates to a medium processing device, a medium processing method, and a medium processing program.

### BACKGROUND ART

In recent years, a video/audio reproduction device that digitizes a video/audio obtained by capturing and recording at a certain point, transmits the digitized video/audio to a remote location in real time via a communication line such as an Internet Protocol (IP) network, and reproduces the video/audio in the remote location has been used. For example, public viewing or the like in which a video/audio of a sports competition held at a competition site or a video/audio of a music concert held at a concert site are transmitted to a remote location in real time is actively performed. Such video/audio transmission is not limited to one-to-one unidirectional transmission. Bidirectional transmission is also performed in which a video/audio is transmitted from a site where a sports competition is held (hereinafter, referred to as an event site) to a plurality of remote locations, a video of an audience who enjoys the event and an audio of cheers and the like are obtained by capturing and recording in each of the plurality of remote locations, the video/audio is transmitted to the event site or another remote location, and the video/audio are output from a large video display device or a speaker at each base.

By such bidirectional transmission of a video/audio, players (or performers) and an audience in an event site, and viewers in a plurality of remote locations can obtain a realistic feeling and a sense of unity as if they were in the same space (event site) and having the same experience even though they were physically located away from each other.

A real-time transport protocol (RTP) is often used in real-time transmission of a video/audio by an IP network, but a data transmission time between two bases varies depending on a communication line or the like connecting the two bases. For example, a case is considered in which a video/audio obtained by capturing and recording at a time T at an event site A is transmitted to two remote locations B and C, and a video/audio obtained by capturing and recording in each of the remote locations B and C is returned and transmitted to the event site A. The video/audio obtained by capturing and recording at the time T and transmitted from the event site A in the remote location B is reproduced at a time T_{b1}, and a video/audio obtained by capturing and recording at the time T_{b1} in the remote location B is returned and transmitted to the event site A and reproduced at a time T_{b2} at the event site A. At this time, the video/audio obtained by capturing and recording at the time T and transmitted at the event site A may be reproduced at a time T_{c1} (≠T_{b1}) in the remote location C and a video/audio obtained by capturing and recording at the time T_{c1} in the remote location C may be returned and transmitted to the event site A and reproduced at a time T_{c2} (≠T_{b2}) at the event site A.

In such a case, players (or performers) and an audience in the event site A view videos/audios indicating how viewing in the plurality of remote locations has reacted to an event experienced by themselves at the time T at different times (time T_{b2} and time T_{c2}). For the players (or performers) and the audience in the event site A, enhancing a sense of unity with the audience in the remote locations may be difficult because lack of intuitive comprehension or unnaturalness of connection with their own experience is caused. Furthermore, also when the video/audio transmitted from the event site A and the video/audio transmitted from the remote location B are reproduced in the remote location C, the audience in the remote location C may feel the above-described lack of intuitive comprehension or unnaturalness.

In order to eliminate such lack of intuitive comprehension or unnaturalness, conventionally, a method of synchronously reproducing a plurality of videos/plurality of audios transmitted from a plurality of remote locations in the event site A is used. In a case where reproduction timings of videos/audios are synchronized, time synchronization is performed using a network time protocol (NTP), a precision time protocol (PTP), or the like so that both the transmission side and the reception side manage the same time information, and video/audio data is packetized into RTP packets at the time of transmission. At this time, in general, an absolute time of a moment of sampling the videos/audios is provided as an RTP time stamp, and the reception side delays at least one or more videos and audios of videos and audios on the basis of the time information to adjust timings, and synchronizes the videos/audios (Non Patent Literature 1).

### CITATION LIST

### Non Patent Literature

Non Patent Literature 1: Synchronization for Acoustic Signals over IP Network (Tokumoto, Ikedo, Kaneko, Kataoka, the transactions of the Institute of Electronics, Information and Communication Engineers D-II Vol. J87-D-II No. 9 pp. 1870-1883)

### SUMMARY OF INVENTION

### Technical Problem

However, in the conventional video/audio reproduction synchronization method, a reproduction timing is matched with a video or audio having the largest delay time, and there is an issue that the real-time property of reproduction timings of videos/audios is lost, and discomfort felt by viewers is difficult to be reduced. That is, reproduction of videos/audios needs to be devised so that the above-described discomfort felt by viewers when a plurality of videos/audios transmitted from a plurality of bases is reproduced at different times is reduced.

The present invention has been made in view of the above circumstances, and an object of the present invention is to provide a technology of reducing discomfort felt by viewers when a plurality of videos/audios transmitted from a plurality of bases at different times is reproduced.

### Solution to Problem

In an embodiment of the present invention, a medium processing device is a device of a first base, including a reception unit that receives a packet that stores a second medium acquired in a second base at a time at which a first medium acquired at a first time in the first base is reproduced in the second base, and a processing unit that generates a third medium from the second medium according to a processing mode based on a second time associated with reception of a packet that stores the second medium and the first time, and outputs the third medium to a presentation device.

### Advantageous Effects of Invention

According to one aspect of the present invention, discomfort felt by viewers when a plurality of videos/audios transmitted from a plurality of bases at different times is reproduced can be reduced.

### BRIEF DESCRIPTION OF DRAWINGS

FIG. 1 is a block diagram illustrating an example of a hardware configuration of each electronic device included in a medium processing system according to a first embodiment.

FIG. 2 is a block diagram illustrating an example of a software configuration of each electronic device included in the medium processing system according to the first embodiment.

FIG. 3 is a diagram illustrating an example of a data structure of a video time management DB included in a server of a base R₁ according to the first embodiment.

FIG. 4 is a diagram illustrating an example of a data structure of an audio time management DB included in the server of the base R₁ according to the first embodiment.

FIG. 5 is a flowchart illustrating a video processing procedure and processing content of a server in a base O according to the first embodiment.

FIG. 6 is a flowchart illustrating a video processing procedure and processing content of the server in the base R₁ according to the first embodiment.

FIG. 7 is a flowchart illustrating a transmission processing procedure and processing content of an RTP packet that stores a video V_{signal1} of the server in the base O according to the first embodiment.

FIG. 8 is a flowchart illustrating a reception processing procedure and processing content of an RTP packet that stores a video V_{signal1} of the server in the base R₁ according to the first embodiment.

FIG. 9 is a flowchart illustrating a calculation processing procedure and processing content of a presentation time t₁ of the server in the base R₁ according to the first embodiment.

FIG. 10 is a flowchart illustrating a transmission processing procedure and processing content of an RTP packet that stores a video V_{signal2} of the server in the base R₁ according to the first embodiment.

FIG. 11 is a flowchart illustrating a reception processing procedure and processing content of an RTP packet that stores a video V_{signal2} of the server in the base O according to the first embodiment.

FIG. 12 is a flowchart illustrating a process processing procedure and processing content of a video V_{signal2} of the server in the base O according to the first embodiment.

FIG. 13 is a flowchart illustrating an audio processing procedure and processing content of the server in the base O according to the first embodiment.

FIG. 14 is a flowchart illustrating an audio processing procedure and processing content of the server in the base R₁ according to the first embodiment.

FIG. 15 is a flowchart illustrating a transmission processing procedure and processing content of an RTP packet that stores an audio A_{signal1} of the server in the base O according to the first embodiment.

FIG. 16 is a flowchart illustrating a reception processing procedure and processing content of an RTP packet that stores an audio A_{signal1} of the server in the base R₁ according to the first embodiment.

FIG. 17 is a flowchart illustrating a transmission processing procedure and processing content of an RTP packet that stores an audio A_{signal2} of the server in the base R₁ according to the first embodiment.

FIG. 18 is a flowchart illustrating a reception processing procedure and processing content of an RTP packet that stores an audio A_{signal2} of the server in the base O according to the first embodiment.

FIG. 19 is a flowchart illustrating a process processing procedure and processing content of an audio A_{signal2} of the server in the base O according to the first embodiment.

FIG. 20 is a block diagram illustrating an example of a hardware configuration of each electronic device included in a medium processing system according to a second embodiment.

FIG. 21 is a block diagram illustrating an example of a software configuration of each electronic device included in the medium processing system according to the second embodiment.

FIG. 22 is a diagram illustrating an example of a data structure of an audio time management DB included in a server of a base R₂ according to the second embodiment.

FIG. 23 is a flowchart illustrating a video processing procedure and processing content of a server in a base R₁ according to the second embodiment.

FIG. 24 is a flowchart illustrating a video processing procedure and processing content of the server in the base R₂ according to the second embodiment.

FIG. 25 is a flowchart illustrating a process processing procedure and processing content of a video V_{signal2} of the server in the base R₂ according to the second embodiment.

FIG. 26 is a flowchart illustrating an audio processing procedure and processing content of the server in the base R₁ according to the second embodiment.

FIG. 27 is a flowchart illustrating an audio processing procedure and processing content of the server in the base R₂ according to the second embodiment.

FIG. 28 is a flowchart illustrating a reception processing procedure and processing content of an RTP packet that stores an audio A_{signal1} of the server in the base R₂ according to the second embodiment.

FIG. 29 is a flowchart illustrating a calculation processing procedure and processing content of a presentation time t₂ of the server in the base R₂ according to the second embodiment.

FIG. 30 is a flowchart illustrating a process processing procedure and processing content of an audio A_{signal2} of the server in the base R₂ according to the second embodiment.

### DESCRIPTION OF EMBODIMENTS

Hereinafter, some embodiments according to the present invention will be described with reference to the drawings.

Time information uniquely determined with respect to an absolute time at which a video/audio is obtained by capturing and recording in a base O serving as an event site such as a competition site or a concert site is provided to a video/audio transmitted to bases R₁ to Rₙ (n is an integer of 2 or more) in a plurality of remote locations. In each of the bases R₁ to Rₙ, a video/audio obtained by capturing and recording at a time at which a video/audio having the time information is reproduced is associated with the time information. When reproducing a video/audio transmitted from each of the bases R₁ to Rₙ in the base O, processing is performed on the video/audio on the basis of the time information and the reproduction is performed.

The time information is transmitted and received between the base O and each of the bases R₁ to Rₙ by any one of the following means. The time information is associated with a video/audio obtained by capturing and recording in each of the bases R₁ to Rₙ.

(1) The time information is stored in a header extension area of an RTP packet transmitted and received between the base O and each of the bases R₁ to Rₙ. For example, the time information is in an absolute time format (hh:mm:ss.fff format), but may be in a millisecond format.

(2) The time information is described using an application-defined (APP) in an RTP control protocol (RTCP) transmitted and received at constant intervals between the base O and each of the bases R₁ to Rₙ. In this example, the time information is in a millisecond format.

(3) The time information is stored in a session description protocol (SDP) that describes initial value parameters exchanged between the base O and each of the bases R₁ to Rₙ at the start of transmission. In this example, the time information is in a millisecond format.

### First Embodiment

A first embodiment is an embodiment in which videos/audios transmitted from the bases R₁ to R₂ back in the base O are processed and reproduced.

Time information used for processing a video/audio is stored in a header extension area of an RTP packet transmitted and received between the base O and each of the bases R₁ to Rₙ. For example, the time information is in an absolute time format (hh:mm:ss.fff format).

Although a video and an audio are described as being transmitted and received in RTP packetization, the present invention is not limited thereto. The video and audio may be processed and managed by the same functional unit/database (DB). Both the videos and audios may be stored in one RTP packet and transmitted and received. The video and audio are examples of a medium.

### Configuration Example

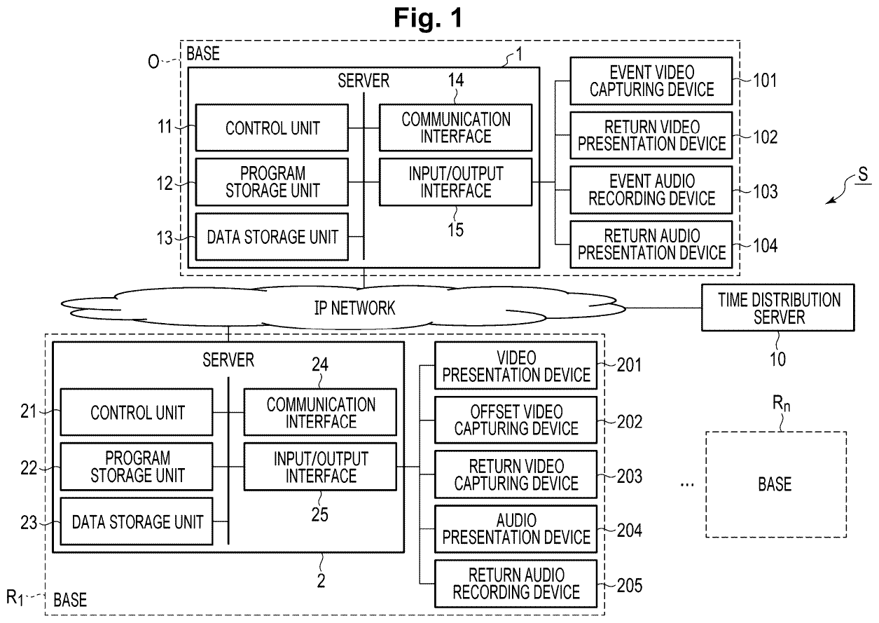

FIG. 1 is a block diagram illustrating an example of a hardware configuration of each electronic device included in a medium processing system S according to the first embodiment.

The medium processing system S includes a plurality of electronic devices included in the base O, a plurality of electronic devices included in each of the bases R₁ to Rₙ, and a time distribution server 10. The electronic devices in each of the bases and the time distribution server 10 can communicate with each other via an IP network.

The base O includes a server 1, an event video capturing device 101, a return video presentation device 102, an event audio recording device 103, and a return audio presentation device 104. The base O is an example of a first base.

The server 1 is an electronic device that controls each of the electronic devices included in the base O. The server 1 is an example of a medium processing device.

The event video capturing device 101 is a device including a camera that captures a video of the base O. The event video capturing device 101 is an example of a video capturing device.

The return video presentation device 102 is a device including a display that reproduces and displays a video returned and transmitted from each of the bases R₁ to Rₙ to the base O. For example, the display is a liquid crystal display. The return video presentation device 102 is an example of a video presentation device or a presentation device.

The event audio recording device 103 is a device including a microphone that records an audio of the base O. The event audio recording device 103 is an example of an audio recording device.

The return audio presentation device 104 is a device including a speaker that reproduces and outputs an audio returned and transmitted from each of the bases R₁ to Rₙ to the base O. The return audio presentation device 104 is an example of an audio presentation device or a presentation device.

A configuration example of the server 1 will be described.

The server 1 includes a control unit 11, a program storage unit 12, a data storage unit 13, a communication interface 14, and an input/output interface 15. The elements included in the server 1 are connected to each other via a bus.

The control unit 11 corresponds to a central part of the server 1. The control unit 11 includes a processor such as a central processing unit (CPU). The control unit 11 includes a read only memory (ROM) as a nonvolatile memory area. The control unit 11 includes a random access memory (RAM) as a volatile memory area. The processor deploys the ROM or a program stored in the program storage unit 12 in the RAM. The processor executes a program deployed in the RAM, thereby the control unit 11 implements each functional unit described below. The control unit 11 is included in a computer.

The program storage unit 12 includes a non-volatile memory capable of writing and reading as needed, such as a hard disk drive (HDD) or a solid state drive (SSD) as a storage medium. The program storage unit 12 stores programs necessary for executing various types of control processing. For example, the program storage unit 12 stores a program for causing the server 1 to execute processing by each functional unit to be described below implemented by the control unit 11. The program storage unit 12 is an example of a storage.

The data storage unit 13 includes a non-volatile memory capable of writing and reading as needed, such as an HDD or an SSD as a storage medium. The data storage unit 13 is an example of a storage or a storage unit.

The communication interface 14 includes various interfaces that communicatively connect the server 1 to other electronic devices using a communication protocol defined by the IP network.

The input/output interface 15 is an interface that enables communication between the server 1 and each of the event video capturing device 101, the return video presentation device 102, the event audio recording device 103, and the return audio presentation device 104. The input/output interface 15 may include an interface for wired communication or an interface for wireless communication.

Note that a hardware configuration of the server 1 is not limited to the above-described configuration. The server 1 can appropriately omit and change the above-described components and add a new component.

The base R₁ includes a server 2, a video presentation device 201, an offset video capturing device 202, a return video capturing device 203, an audio presentation device 204, and a return audio recording device 205. The base R₁ is an example of a second base different from the first base.

The server 2 is an electronic device that controls each of the electronic devices included in the base R₁.

The video presentation device 201 is a device including a display that reproduces and displays a video transmitted from the base O to the base R₁. The video presentation device 201 is an example of the presentation device.

The offset video capturing device 202 is a device capable of recording a capturing time. The offset video capturing device 202 is a device including a camera installed so as to be able to capture the entire video display area of the video presentation device 201. The offset video capturing device 202 is an example of the video capturing device.

The return video capturing device 203 is a device including a camera that captures a video of the base R₁. For example, the return video capturing device 203 captures a video of a state of the base R₁ where the video presentation device 201 that reproduces and displays a video transmitted from the base O to the base R₁ is installed. The return video capturing device 203 is an example of the video capturing device.

The audio presentation device 204 is a device including a speaker that reproduces and outputs an audio transmitted from the base O to the base R₁. The audio presentation device 204 is an example of the presentation device.

The return audio recording device 205 is a device including a microphone that records an audio of the base R₁. For example, the return audio recording device 205 records an audio of a state of the base R₁ where the audio presentation device 204 that reproduces and outputs an audio transmitted from the base O to the base R₁ is installed. The return audio recording device 205 is an example of the audio recording device.

A configuration example of the server 2 will be described.

The server 2 includes a control unit 21, a program storage unit 22, a data storage unit 23, a communication interface 24, and an input/output interface 25. The elements included in the server 2 are connected to each other via a bus.

The control unit 21 can be formed similarly to the control unit 11. A processor deploys a ROM or a program stored in the program storage unit 22 in a RAM. The processor executes a program deployed in the RAM, thereby the control unit 21 implements each functional unit described below. The control unit 21 is included in a computer.

The program storage unit 22 can be formed similarly to the program storage unit 12.

The data storage unit 23 can be formed similarly to the data storage unit 13.

The communication interface 24 can be formed similarly to the communication interface 14. The communication interface 14 includes various interfaces that communicatively connect the server 2 to other electronic devices.

The input/output interface 25 can be formed similarly to the input/output interface 15. The input/output interface 25 enables communication between the server 2 and each of the video presentation device 201, the offset video capturing device 202, the return video capturing device 203, the audio presentation device 204, and the return audio recording device 205.

Note that a hardware configuration of the server 2 is not limited to the above-described configuration. The server 2 can appropriately omit and change the above-described components and add a new component.

Since hardware configurations of a plurality of electronic devices included in each of bases R₂ to Rₙ are similar to those of the base R₁ described above, description thereof will be omitted.

The time distribution server 10 is an electronic device that manages a reference system clock. The reference system clock is an absolute time.

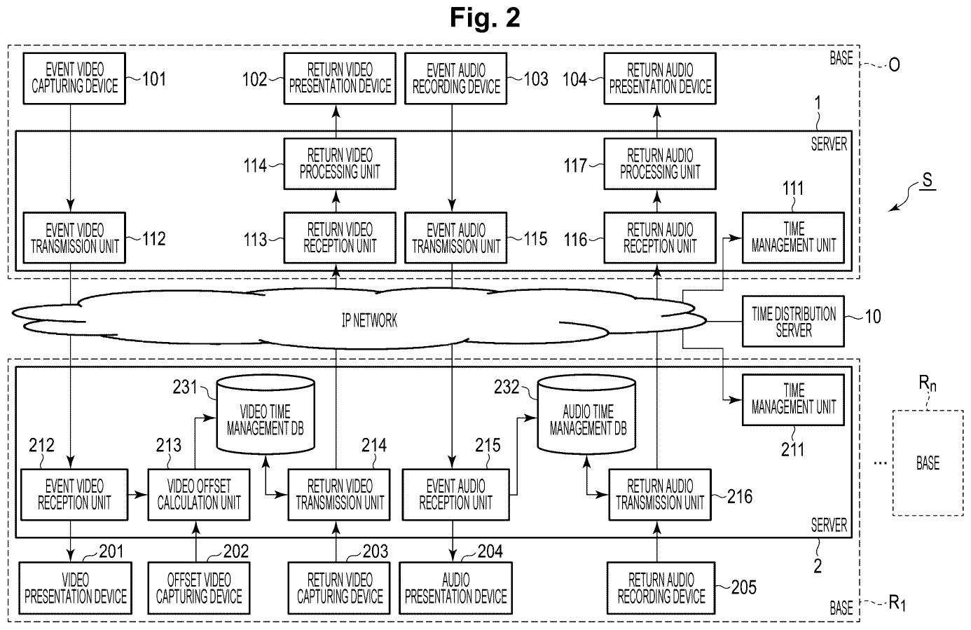

FIG. 2 is a block diagram illustrating an example of a software configuration of each of the electronic devices included in the medium processing system S according to the first embodiment.

The server 1 includes a time management unit 111, an event video transmission unit 112, a return video reception unit 113, a return video processing unit 114, an event audio transmission unit 115, a return audio reception unit 116, and a return audio processing unit 117. Each functional unit is implemented by execution of a program by the control unit 11. It can also be said that each functional unit is included in the control unit 11 or the processor. Each functional unit can be read as the control unit 11 or the processor.

The time management unit 111 performs time synchronization with the time distribution server 10 using a known protocol such as NTP or PTP, and manages the reference system clock. The time management unit 111 manages the same reference system clock as the reference system clock managed by the server 2. The reference system clock managed by the time management unit 111 and the reference system clock managed by the server 2 are time-synchronized.

The event video transmission unit 112 transmits an RTP packet that stores a video V_{signal1} output from the event video capturing device 101 to each of servers of the bases R₁ to Rₙ via the IP network. The video V_{signal1} is a video acquired at a time T_{video} that is an absolute time in the base O. Acquiring the video V_{signal1} includes capturing the video V_{signal1} by the event video capturing device 101. Acquiring the video V_{signal1} includes sampling the video V_{signal1} obtained by capturing by the event video capturing device 101. A time T_{video} is provided to the RTP packet that stores the video V_{signal1}. The time T_{video} is a time at which the video V_{signal1} is acquired in the base O. The time T_{video} is time information for processing return videos at the base O. The video V_{signal1} is an example of a first video. The time T_{video} is an example of a first time. An RTP packet is an example of a packet. The event video transmission unit 112 is an example of a transmission unit.

The return video reception unit 113 receives an RTP packet that stores a video V_{signal1} from each of servers of the bases R₁ to Rₙ via the IP network. The video V_{signal2} is a video acquired in any one of the bases R₁ to Rₙ at a time at which the video V_{signal1} is reproduced in this base. Acquiring the video V_{signal2} includes capturing the video V_{signal2} by the return video capturing device 203. Acquiring the video V_{signal2} includes sampling the video V_{signal2} obtained by capturing by the return video capturing device 203. The time T_{video} is provided to the RTP packet that stores the video V_{signal2}. The video V_{signal2} is an example of a second video. The return video reception unit 113 is an example of a reception unit.

The return video processing unit 114 generates a video V_{signal3} from the video V_{signal2} and outputs the video V_{signal3} to the return video presentation device 102. The video V_{signal3} is an example of a third video. The return video processing unit 114 is an example of a processing unit.

The event audio transmission unit 115 transmits an RTP packet that stores an audio A_{signal1} output from the event audio recording device 103 to each of the servers of the bases R₁ to Rₙ via the IP network. The audio A_{signal1} is an audio acquired at a time T_{audio} that is an absolute time in the base O. Acquiring the audio A_{signal1} includes recording the audio A_{signal1} by the event audio recording device 103. Acquiring the audio A_{signal1} includes sampling the audio A_{signal1} obtained by recording by the event audio recording device 103. The time T_{audio} is provided to the RTP packet that stores the audio A_{signal1}. The time T_{audio} is a time at which the audio A_{signal1} is acquired in the base O. The time T_{audio} is time information for processing return audios at the base O. The audio A_{signal1} is an example of a first audio. The time T_{audio} is an example of the first time. The event audio transmission unit 115 is an example of the transmission unit.

The return audio reception unit 116 receives the RTP packet that stores the audio A_{signal2} from each of the servers of the bases R₁ to R₂ via the IP network. The audio A_{signal2} is an audio acquired in any one of the bases R₁ to Rₙ at a time at which the audio A_{signal1} is reproduced in this base. Acquiring the audio A_{signal2} includes recording the audio A_{signal2} by the return audio recording device 205. Acquiring the audio A_{signal2} includes sampling the audio A_{signal2} obtained by recording by the return audio recording device 205. The time T_{audio} is provided to the RTP packet that stores the audio A_{signal2}. The audio A_{signal2} is an example of a second audio. The return audio reception unit 116 is an example of the reception unit.

The return audio processing unit 117 generates an audio A_{signal3} from the audio A_{signal2} and outputs the audio A_{signal3} to the return audio presentation device 104. The audio A_{signal3} is an example of a third audio. The return audio processing unit 117 is an example of the processing unit.

The server 2 includes a time management unit 211, an event video reception unit 212, a video offset calculation unit 213, a return video transmission unit 214, an event audio reception unit 215, a return audio transmission unit 216, a video time management DB 231, and an audio time management DB 232. Each functional unit is implemented by execution of a program by the control unit 21. It can also be said that each functional unit is included in the control unit 21 or a processor. Each functional unit can be read as the control unit 21 or the processor. The video time management DB 231 and the audio time management DB 232 are implemented by the data storage unit 23.

The time management unit 211 performs time synchronization with the time distribution server 10 using a known protocol such as NTP or PTP, and manages the reference system clock. The time management unit 211 manages the same reference system clock as the reference system clock managed by the server 1. The reference system clock managed by the time management unit 211 and the reference system clock managed by the server 1 are time-synchronized.

The event video reception unit 212 receives an RTP packet that stores a video V_{signal1} from the server 1 via the IP network. The event video reception unit 212 outputs the video V_{signal1} to the video presentation device 201. The video offset calculation unit 213 calculates a presentation time t₁ that is an absolute time at which the video V_{signal1} is reproduced by the video presentation device 201.

The return video transmission unit 214 transmits an RTP packet that stores a video V_{signal2} to the server 1 via the IP network. The RTP packet that stores the video V_{signal2} includes a time T_{video} associated with the presentation time t₁ that matches a time t that is an absolute time at which the video V_{signal2} is obtained by capturing.

The event audio reception unit 215 receives an RTP packet that stores an audio A_{signal1} from the server 1 via the IP network. The event audio reception unit 215 outputs the audio A_{signal1} to the audio presentation device 204.

The return audio transmission unit 216 transmits an RTP packet that stores an audio A_{signal2} to the server 1 via the IP network. The RTP packet that stores the audio A_{signal2} includes a time T_{audio}.

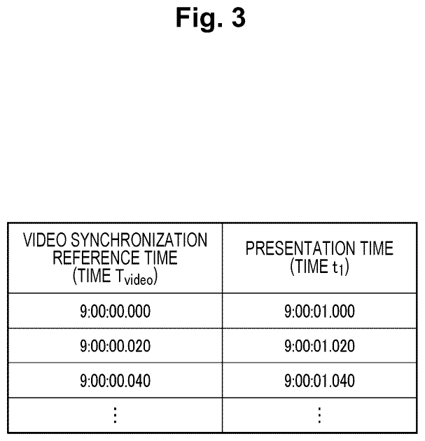

FIG. 3 is a diagram illustrating an example of a data structure of the video time management DB 231 included in the server 2 of the base R₁ according to the first embodiment.

The video time management DB 231 is a DB that stores times T_{video} acquired from the video offset calculation unit 213 and presentation times t₁ in association with each other.

The video time management DB 231 includes a video synchronization reference time column and a presentation time column. The video synchronization reference time column stores the times T_{video}. The presentation time column stores the presentation times t₁.

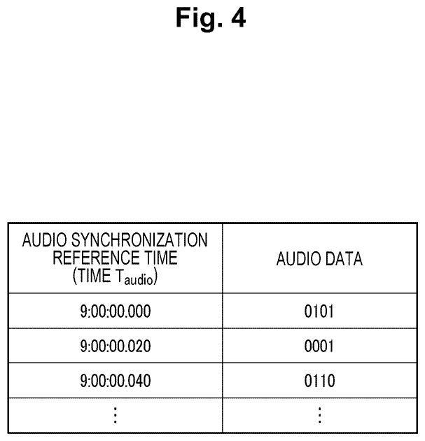

FIG. 4 is a diagram illustrating an example of a data structure of the audio time management DB 232 included in the server 2 of the base R₁ according to the first embodiment.

The audio time management DB 232 is a DB that stores times T_{audio} acquired from the event audio reception unit 215 and audios A_{signal1} in association with each other.

The audio time management DB 232 includes an audio synchronization reference time column and an audio data column. The audio synchronization reference time column stores the times T_{audio}. The audio data column stores the audios A_{signal1}.

Each of the servers of the bases R₂ to R₂ includes functional units and a DB similar to those of the server 1 of the base R₁, and performs processing similar to that of the server 1 of the base R₁. Description of a processing flow and a DB structure of the functional units included in each of the servers of the bases R₂ to Rₙ will be omitted.

### Operation Example

Hereinafter, operation of the base O and the base R₁ will be described as an example. Operation of the bases R₂ to Rₙ may be similar to operation of the base R₁, and description thereof will be omitted. The notation of the base R₁ may be read as the bases R₂ to Rₙ.

### (1) Process and Reproduce Return Video

Video processing of the server 1 in the base O will be described.

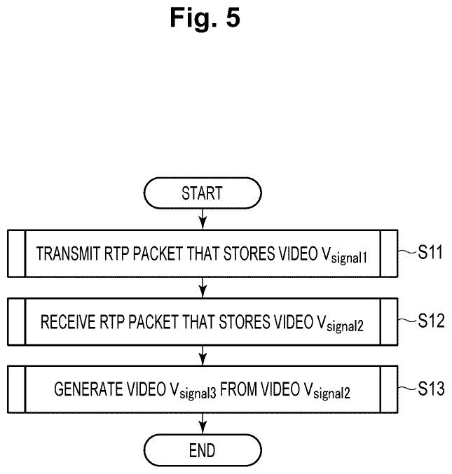

FIG. 5 is a flowchart illustrating a video processing procedure and processing content of the server 1 in the base O according to the first embodiment.

The event video transmission unit 112 transmits an RTP packet that stores a video V_{signal1} to the server 2 of the base R₁ via the IP network (step S11). A typical example of processing of step S11 will be described below.

The return video reception unit 113 receives an RTP packet that stores a video V_{signal2} from the server 2 of the base R₁ via the IP network (step S12). A typical example of processing of step S12 will be described below.

The return video processing unit 114 generates a video V_{signal3} from the video V_{signal2} according to a processing mode based on a current time Tₙ and a time T_{video} associated with reception of the RTP packet that stores the video V_{signal2} by the return video reception unit 113. The return video processing unit 114 outputs the video V_{signal3} to the return video presentation device 102 (step S13). A typical example of processing of step S13 will be described below.

Video processing of the server 2 in the base R₁ will be described.

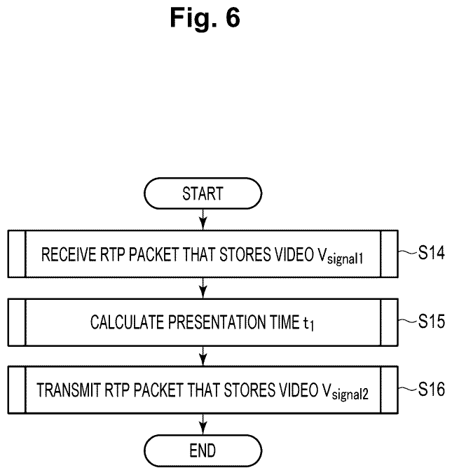

FIG. 6 is a flowchart illustrating a video processing procedure and processing content of the server 2 in the base R₁ according to the first embodiment.

The event video reception unit 212 receives an RTP packet that stores a video V_{signal1} from the server 1 via the IP network (step S14). A typical example of processing of step S14 will be described below.

The video offset calculation unit 213 calculates a presentation time t₁ at which the video V_{signal1} is reproduced by the video presentation device 201 (step S15). A typical example of processing of step S15 will be described below.

The return video transmission unit 214 transmits an RTP packet that stores a video V_{signal2} to the server 1 via the IP network (step S16). A typical example of processing of step S16 will be described below.

Hereinafter, typical examples of processing of steps S11 to S13 of the server 1 described above and processing of steps S14 to S16 of the server 2 described above will be described. In order of the processing in chronological order, the processing in step S11 of the server 1, the processing in step S14 of the server 2, the processing in step S15 of the server 2, the processing in step S16 of the server 2, the processing in step S12 of the server 1, and the processing in step S13 of the server 1 will be described in this order.

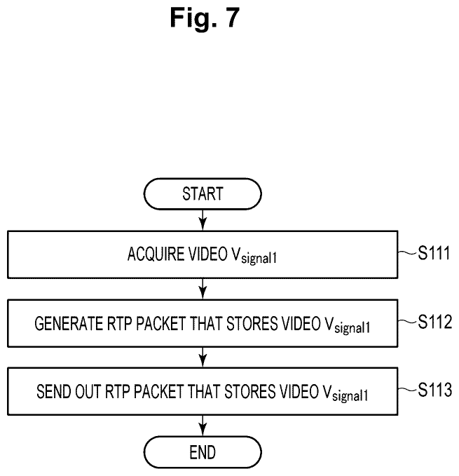

FIG. 7 is a flowchart illustrating a transmission processing procedure and processing content of an RTP packet that stores a video V_{signal1} of the server 1 in the base O according to the first embodiment. FIG. 7 illustrates the typical example of the processing of step S11.

The event video transmission unit 112 acquires a video V_{signal1} output from the event video capturing device 101 at constant intervals I_{video} (step S111).

The event video transmission unit 112 generates an RTP packet that stores the video V_{signal1} (step S112). In step S112, for example, the event video transmission unit 112 stores the acquired video V_{signal1} in an RTP packet. The event video transmission unit 112 acquires a time T_{video} that is an absolute time at which the video V_{signal1} is sampled from the reference system clock managed by the time management unit 111. The event video transmission unit 112 stores the acquired time T_{video} in the header extension area of the RTP packet.

The event video transmission unit 112 sends out the generated RTP packet that stores the video V_{signal1} to the IP network (step S113).

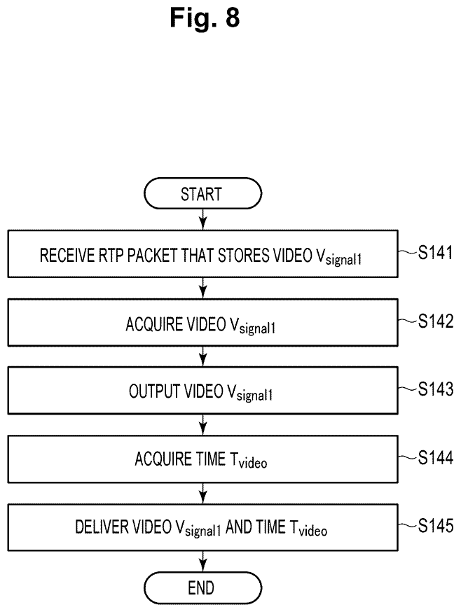

FIG. 8 is a flowchart illustrating a reception processing procedure and processing content of an RTP packet that stores a video V_{signal1} of the server 2 in the base R₁ according to the first embodiment. FIG. 8 illustrates the typical example of the processing of step S14 of the server 2.

The event video reception unit 212 receives an RTP packet that stores a video V_{signal1} sent out from the event video transmission unit 112 via the IP network (step S141). The event video reception unit 212 acquires the video V_{signal1} stored in the received RTP packet that stores the video V_{signal1} (step S142).

The event video reception unit 212 outputs the acquired video V_{signal1} to the video presentation device 201 (step S143). The video presentation device 201 reproduces and displays the video V_{signal1}.

The event video reception unit 212 acquires a time T_{video} stored in the header extension area of the received RTP packet that stores the video V_{signal1} (step S144).

The event video reception unit 212 delivers the acquired video V_{signal1} and time T_{video} to the video offset calculation unit 213 (step S145).

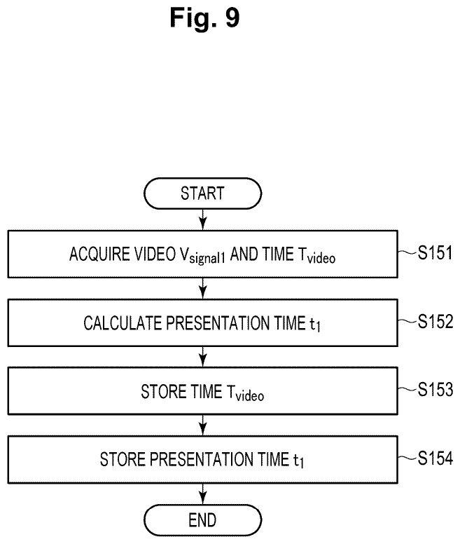

FIG. 9 is a flowchart illustrating a calculation processing procedure and processing content of a presentation time t₁ of the server 2 in the base R₁ according to the first embodiment. FIG. 9 illustrates the typical example of the processing of step S15 of the server 2.

The video offset calculation unit 213 acquires a video V_{signal1} and a time T_{video} from the event video reception unit 212 (step S151).

The video offset calculation unit 213 calculates a presentation time t₁ on the basis of the acquired video V_{signal1} and a video input from the offset video capturing device 202 (step S152). In step S152, for example, the video offset calculation unit 213 extracts a video frame including the video V_{signal1} from the video obtained by capturing by the offset video capturing device 202 using a known image processing technology. The video offset calculation unit 213 acquires a capturing time provided to the extracted video frame as the presentation time t₁. The capturing time is an absolute time.

The video offset calculation unit 213 stores the acquired time T_{video} in the video synchronization reference time column of the video time management DB 231 (step S153).

The video offset calculation unit 213 stores the acquired presentation time t₁ in the presentation time column of the video time management DB 231 (step S154).

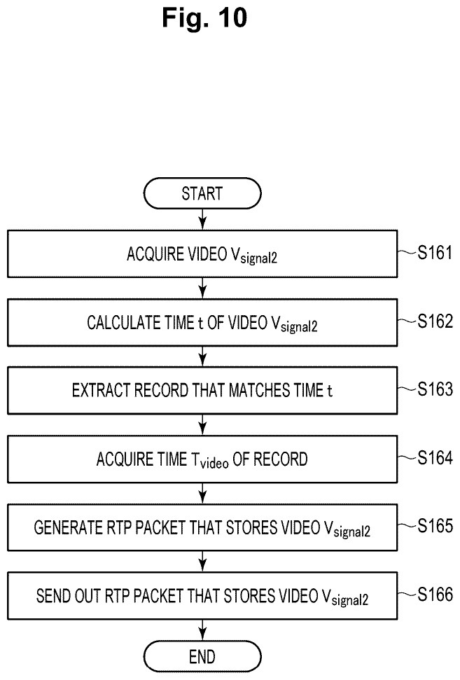

FIG. 10 is a flowchart illustrating a transmission processing procedure and processing content of an RTP packet that stores a video V_{signal2} of the server 2 in the base R₁ according to the first embodiment. FIG. 10 illustrates the typical example of the processing of step S16 of the server 2.

The return video transmission unit 214 acquires a video V_{signal2} output from the return video capturing device 203 at the constant intervals I_{video} (step S161). The video V_{signal2} is a video acquired in the base R₁ at a time at which the video presentation device 201 reproduces a video V_{signal1} in the base R₁.

The return video transmission unit 214 calculates a time t that is an absolute time at which the acquired video V_{signal2} is obtained by capturing (step S162). In step S162, for example, in a case where a time code T_{c} (absolute time) representing a capturing time is provided to the video V_{signal2}, the return video transmission unit 214 acquires the time t as t=T_{c}. In a case where the time code T_{c} is not provided to the video V_{signal2}, the return video transmission unit 214 acquires a current time Tₙ from the reference system clock managed by the time management unit 211. The return video transmission unit 214 acquires the time t as t=Tₙ−t_{video_offset} using a predetermined value t_{video_offset} (positive number).

The return video transmission unit 214 refers to the video time management DB 231 and extracts a record having a time t₁ that matches the acquired time t (step S163).

The return video transmission unit 214 refers to the video time management DB 231 and acquires a time T_{video} in the video synchronization reference time column of the extracted record (step S164).

The return video transmission unit 214 generates an RTP packet that stores the video V_{signal2} (step S165). In step S165, for example, the return video transmission unit 214 stores the acquired video V_{signal2} in an RTP packet. The return video transmission unit 214 stores the acquired time T_{video} in the header extension area of the RTP packet.

The return video transmission unit 214 sends out the generated RTP packet that stores the video V_{signal2} to the IP network (step S166).

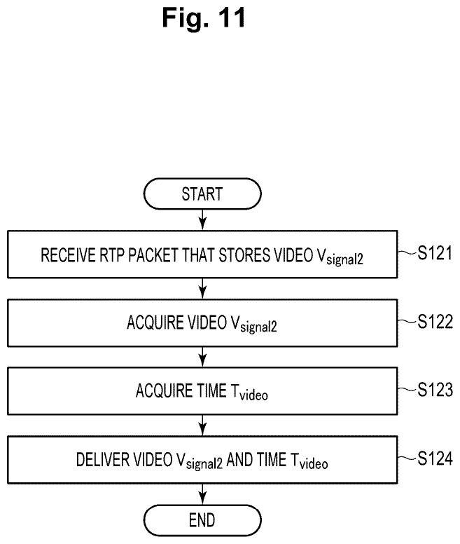

FIG. 11 is a flowchart illustrating a reception processing procedure and processing content of an RTP packet that stores a video V_{signal2} of the server 1 in the base O according to the first embodiment. FIG. 11 illustrates the typical example of the processing of step S12 of the server 1.

The return video reception unit 113 receives an RTP packet that stores a video V_{signal2} sent out from the return video transmission unit 214 via the IP network (step S121).

The return video reception unit 113 acquires the video V_{signal2} stored in the received RTP packet that stores the video V_{signal2} (step S122).

The return video reception unit 113 acquires a time T_{video} stored in the header extension area of the received RTP packet that stores the video V_{signal2} (step S123).

The return video reception unit 113 delivers the acquired video V_{signal2} and time T_{video} to the return video processing unit 114 (step S124).

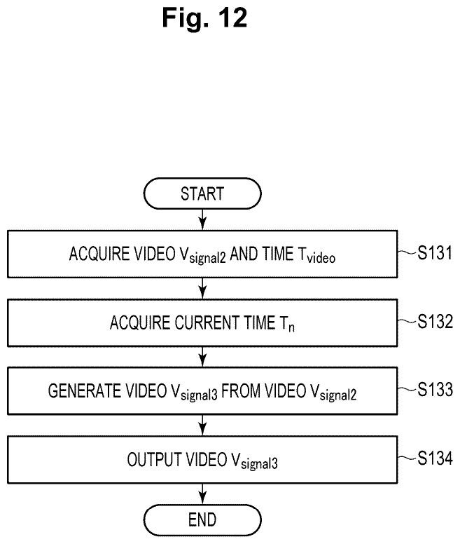

FIG. 12 is a flowchart illustrating a process processing procedure and processing content of a video V_{signal2} of the server 1 in the base O according to the first embodiment. FIG. 12 illustrates the typical example of the processing of step S13 of the server 1.

The return video processing unit 114 acquires a video V_{signal2} and a time T_{video} from the return video reception unit 113 (step S131).

The return video processing unit 114 acquires a current time Tₙ from the reference system clock managed by the time management unit 111 (step S132). The current time Tₙ is a time associated with reception of an RTP packet that stores the video V_{signal2} by the return video reception unit 113. The current time Tₙ can also be referred to as a reception time of the RTP packet that stores the video V_{signal2}. The current time Tₙ can also be referred to as a reproduction time of a video V_{signal3} generated on the basis of the video V_{signal2}. The current time Tₙ associated with the reception of the RTP packet that stores the video V_{signal2} is an example of a second time.

The return video processing unit 114 generates the video V_{signal3} from the acquired video V_{signal2} according to a processing mode based on the acquired current time Tₙ and time T_{video} (step S133). In step S133, for example, the return video processing unit 114 determines the processing mode of the video V_{signal2} on the basis of a value of a difference between the current time Tₙ and the time T_{video}, that is, a value of (Tₙ−T_{video}) (ms). The return video processing unit 114 changes the processing mode of the video V_{signal2} on the basis of the value of the (Tₙ−T_{video}). The return video processing unit 114 changes the processing mode so as to lower the quality of the video as the value of the difference increases. The processing mode may include both performing processing on the video V_{signal2} and not performing processing on the video V_{signal2}. The processing mode includes a degree of processing on the video V_{signal2}. In a case where the return video processing unit 114 performs processing on the video V_{signal2}, the video V_{signal3} is different from the video V_{signal2}. In a case where the return video processing unit 114 does not perform processing on the video V_{signal2}, the video V_{signal3} is the same as the video V_{signal2}.

The return video processing unit 114 performs processing of reducing the visibility when reproduction is performed by the return video presentation device 102. When the value of the (Tₙ−T_{video}) is so small that viewers do not feel discomfort by reproduction of the video V_{signal2} by the return video presentation device 102, the return video processing unit 114 does not perform processing on the video V_{signal2}. Furthermore, even in a case where the value of the (Tₙ−T_{video}) is too large, the return video processing unit 114 performs processing on the video V_{signal2} so that the video does not become completely visually unrecognizable. For example, a case of processing of changing the display size of the video V_{signal2} will be described. Assuming that a horizontal pixel of the video V_{signal2} is w and a vertical pixel is h, a horizontal pixel w′ and a vertical pixel h′ of the video V_{signal3} generated according to the processing mode are as follows.
(1) When 0 ms≤Tₙ−T_{video}≤300 ms,
   q′=q, h′=h
(2) When 300 ms<Tₙ−T_{video}≤500 ms,
   W′={−( 1/400)(Tₙ−T_{video})+7/4}*w, h′={−( 1/400)(Tₙ−T_{video})+7/4}*h
(3) When 500 ms<Tₙ−T_{video},
   q′=0.5*w, h′=0.5*h

The processing is not limited to the above as the change of the quality of the video, and may be, in addition to the above display size change, blurring an image by a Gaussian filter, lowering the luminance of an image, or the like. The processing may use other processing as long as the processed video V_{signal3} has lower visibility than the video V_{signal2}.

The return video processing unit 114 outputs the generated video V_{signal3} to the return video presentation device 102 (step S134). The return video presentation device 102 reproduces and displays the video V_{signal3} based on the video V_{signal2} returned and transmitted from the base R₁ to the base O.

### (2) Process and Reproduce Return Audio

Audio processing of the server 1 in the base O will be described.

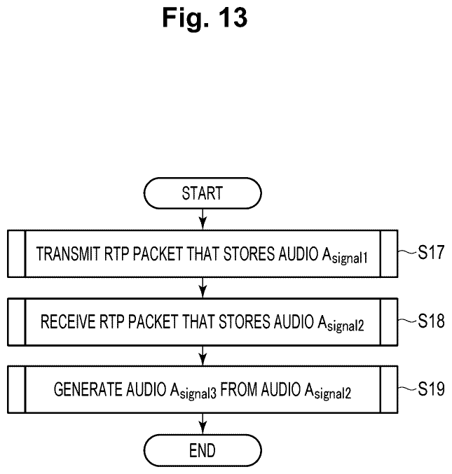

FIG. 13 is a flowchart illustrating an audio processing procedure and processing content of the server 1 in the base O according to the first embodiment.

The event audio transmission unit 115 transmits an RTP packet that stores an audio A_{signal1} to the server 2 of the base R₁ via the IP network (step S17). A typical example of processing of step S17 will be described below.

The return audio reception unit 116 receives an RTP packet that stores an audio A_{signal2} from the server 2 of the base R₁ via the IP network (step S18). A typical example of processing of step S18 will be described below.

The return audio processing unit 117 generates an audio A_{signal3} from the audio A_{signal2} according to a processing mode based on a current time Tₙ and a time T_{audio} associated with reception of the RTP packet that stores the audio A_{signal2} by the return audio reception unit 116. The return audio processing unit 117 outputs the audio A_{signal3} to the return audio presentation device 104 (step S19). A typical example of processing of step S19 will be described below.

Audio processing of the server 2 in the base R₁ will be described.

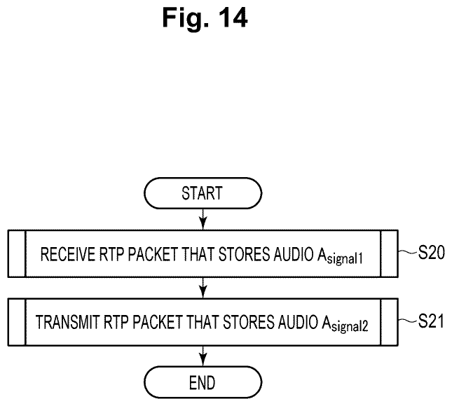

FIG. 14 is a flowchart illustrating an audio processing procedure and processing content of the server 2 in the base R₁ according to the first embodiment.

The event audio reception unit 215 receives an RTP packet that stores an audio A_{signal1} from the server 1 via the IP network (step S20). A typical example of processing of step S20 will be described below.

The return audio transmission unit 216 transmits an RTP packet that stores an audio A_{signal2} to the server 1 via the IP network (step S21). A typical example of processing of step S21 will be described below.

Hereinafter, typical examples of processing of steps S17 to S19 of the server 1 described above and processing of steps S20 to S21 of the server 2 described above will be described. In order of the processing in chronological order, the processing in step S17 of the server 1, the processing in step S20 of the server 2, the processing in step S21 of the server 2, the processing in step S18 of the server 1, and the processing in step S19 of the server 1 will be described in this order.

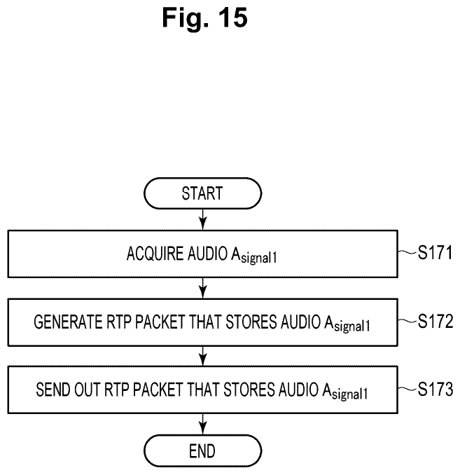

FIG. 15 is a flowchart illustrating a transmission processing procedure and processing content of an RTP packet that stores an audio A_{signal1} of the server 1 in the base O according to the first embodiment. FIG. 15 illustrates the typical example of the processing of step S17 of the server 1.

The event audio transmission unit 115 acquires an audio A_{signal1} output from the event audio recording device 103 at the constant interval I_{audio} (step S171).

The event audio transmission unit 115 generates an RTP packet that stores the audio A_{signal1} (step S172). In step S172, for example, the event audio transmission unit 115 stores the acquired audio A_{signal1} in an RTP packet. The event audio transmission unit 115 acquires a time T_{audio} that is an absolute time at which the acquired audio A_{signal1} is sampled from the reference system clock managed by the time management unit 111. The event audio transmission unit 115 stores the acquired time T_{audio} in the header extension area of the RTP packet.

The event audio transmission unit 115 sends out the generated RTP packet that stores the audio A_{signal1} to the IP network (step S173).

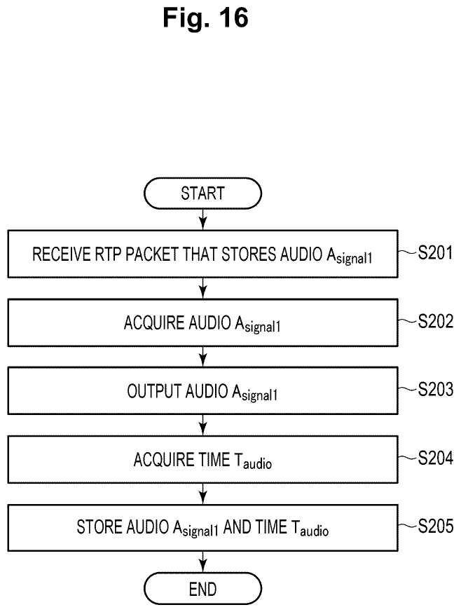

FIG. 16 is a flowchart illustrating a reception processing procedure and processing content of an RTP packet that stores an audio A_{signal1} of the server 2 in the base R₁ according to the first embodiment. FIG. 16 illustrates the typical example of the processing of step S20 of the server 2.

The event audio reception unit 215 receives an RTP packet that stores an audio A_{signal1} sent out from the event audio transmission unit 115 via the IP network (step S201).

The event audio reception unit 215 acquires the audio A_{signal1} stored in the received RTP packet that stores the audio A_{signal1} (step S202).

The event audio reception unit 215 outputs the acquired audio A_{signal1} to the audio presentation device 204 (step S203). The audio presentation device 204 reproduces and outputs the audio A_{signal1}.

The event audio reception unit 215 acquires a time T_{audio} stored in the header extension area of the received RTP packet that stores the audio A_{signal1} (step S204).

The event audio reception unit 215 stores the acquired audio A_{signal1} and time T_{audio} in the audio time management DB 232 (step S205). In step S205, for example, the event audio reception unit 215 stores the acquired time T_{audio} in the audio synchronization reference time column of the audio time management DB 232. The event audio reception unit 215 stores the acquired audio A_{signal1} in the audio data column of the audio time management DB 232.

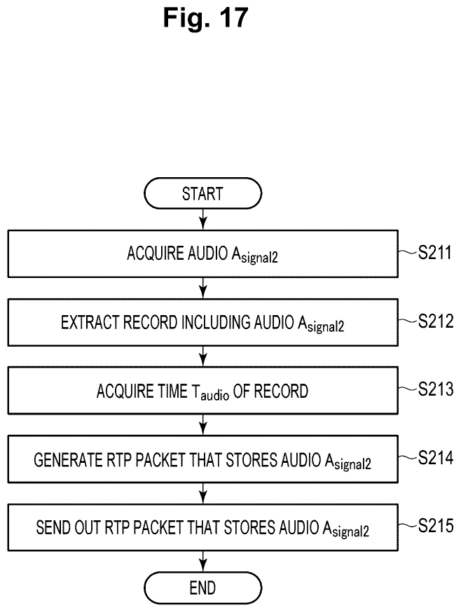

FIG. 17 is a flowchart illustrating a transmission processing procedure and processing content of an RTP packet that stores an audio A_{signal2} of the server 2 in the base R₁ according to the first embodiment. FIG. 17 illustrates the typical example of the processing of step S21 of the server 2.

The return audio transmission unit 216 acquires an audio A_{signal2} output from the return audio recording device 205 at the constant interval I_{audio} (step S211). The audio A_{signal2} is an audio acquired in the base R₁ at a time at which the audio presentation device 204 reproduces an audio A_{signal1} in the base R₁.

The return audio transmission unit 216 refers to the audio time management DB 232 and extracts a record having audio data including the acquired audio A_{signal2} (step S212). The audio A_{signal2} acquired by the return audio transmission unit 216 includes the audio A_{signal1} reproduced by the audio presentation device 204 and an audio generated at the base R₁ (cheers of the audience at the base R₁ and the like). In step S212, for example, the return audio transmission unit 216 separates the two audios by a known audio analysis technology. The return audio transmission unit 216 identifies the audio A_{signal1} reproduced by the audio presentation device 204 by separating the audios. The return audio transmission unit 216 refers to the audio time management DB 232 and searches for audio data that matches the identified audio A_{signal1} reproduced by the audio presentation device 204. The return audio transmission unit 216 refers to the audio time management DB 232 and extracts a record having the audio data that matches the identified audio A_{signal1} reproduced by the audio presentation device 204.

The return audio transmission unit 216 refers to the audio time management DB 232 and acquires a time T_{audio} in the audio synchronization reference time column of the extracted record (step S213).

The return audio transmission unit 216 generates an RTP packet that stores the audio A_{signal2} (step S214). In step S214, for example, the return audio transmission unit 216 stores the acquired audio A_{signal2} in an RTP packet. The return audio transmission unit 216 stores the acquired time T_{audio} in the header extension area of the RTP packet.

The return audio transmission unit 216 sends out the generated RTP packet that stores the audio A_{signal2} to the IP network (step S215).

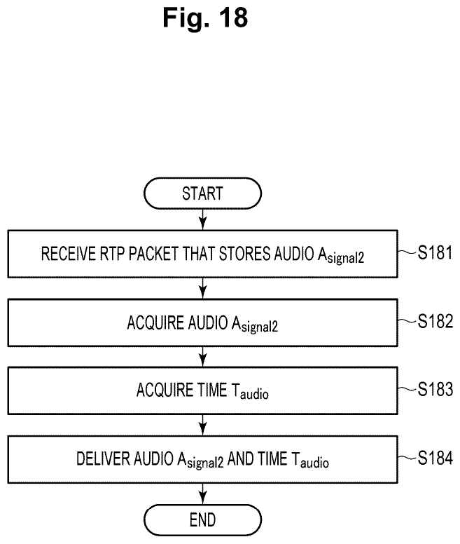

FIG. 18 is a flowchart illustrating a reception processing procedure and processing content of an RTP packet that stores an audio A_{signal2} of the server 1 in the base O according to the first embodiment. FIG. 18 illustrates the typical example of the processing of step S18 of the server 1.

The return audio reception unit 116 receives an RTP packet that stores an audio A_{signal2} sent out from the return audio transmission unit 216 via the IP network (step S181).

The return audio reception unit 116 acquires the audio A_{signal2} stored in the received RTP packet that stores the audio A_{signal2} (step S182).

The return audio reception unit 116 acquires a time T_{audio} stored in the header extension area of the received RTP packet that stores the audio A_{signal2} (step S183).

The return audio reception unit 116 delivers the acquired audio A_{signal2} and time T_{audio} to the return audio processing unit 117 (step S184).

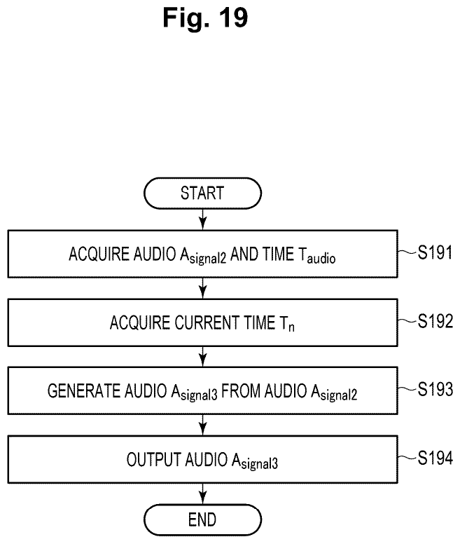

FIG. 19 is a flowchart illustrating a process processing procedure and processing content of an audio A_{signal2} of the server 1 in the base O according to the first embodiment. FIG. 19 illustrates the typical example of the processing of step S19 of the server 1.

The return audio processing unit 117 acquires the audio A_{signal2} and time T_{audio} from the return audio reception unit 116 (step S191).

The return audio processing unit 117 acquires a current time Tₙ from the reference system clock managed by the time management unit 111 (step S192). The current time Tₙ is a time associated with reception of an RTP packet that stores an audio A_{signal2} by the return audio reception unit 116. The current time Tₙ can also be referred to as a reception time of the RTP packet that stores the audio A_{signal2}. The current time Tₙ can also be referred to as a reproduction time of an audio A_{signal3} generated on the basis of the audio A_{signal2}. The current time Tₙ associated with the reception of the RTP packet that stores the audio A_{signal2} is an example of the second time.

The return audio processing unit 117 generates the audio A_{signal3} from the acquired audio A_{signal2} according to a processing mode based on the acquired current time Tₙ and time T_{audio} (step S193). In step S193, for example, the return audio processing unit 117 determines the processing mode of the audio A_{signal2} on the basis of a value of a difference between the current time Tₙ and the time T_{audio}, that is, a value of (In-T_{audio}) (ms). The return audio processing unit 117 changes the processing mode of the audio A_{signal2} on the basis of the value of the (Tₙ−T_{audio}). The return audio processing unit 117 changes the processing mode so as to lower the quality of the audio as the value of the difference increases. The processing mode may include both performing processing on the audio A_{signal2} and not performing processing on the audio A_{signal2}. The processing mode includes a degree of processing on the audio A_{signal2}. In a case where the return audio processing unit 117 performs processing on the audio A_{signal2}, the audio A_{signal3} is different from the audio A_{signal2}. In a case where the return audio processing unit 117 does not perform processing on the audio A_{signal2}, the audio A_{signal3} is the same as the audio A_{signal2}.

The return audio processing unit 117 performs processing of reducing the audibility when reproduction is performed by the return audio presentation device 104. When the value of the (Tₙ−T_{audio}) is so small that viewers do not feel discomfort by reproduction of the audio A_{signal2} by the return audio presentation device 104, the return audio processing unit 117 does not perform processing on the audio A_{signal2}. Furthermore, even in a case where the value of the (Tₙ−T_{audio}) is too large, the return audio processing unit 117 performs processing on the audio A_{signal2} so that the audio does not become completely auditorily unrecognizable. For example, a case of processing of changing the strength of the audio A_{signal2} will be described. Assuming that the strength of the audio A_{signal2} is s, the strength s′ of the audio A_{signal3} generated according to the processing mode is as follows.
(1) When 0 ms≤Tₙ−T_{audio}≤100 ms, s′=s
(2) When 100 ms<Tₙ−T_{audio}≤300 ms, s′={−( 1/400)(Tₙ−T_{audio})+5/4}*s
(3) When 300 ms<Tₙ−T_{audio}, S′=0.5*s

The processing is not limited to the above as the change of the quality of the audio, and may be, in addition to the change of the strength of the sound, gradual reduction of a component of a high frequency by low-pass filtering in which a threshold is smaller as the value of the (Tₙ−T_{audio}) (ms) is larger. In the processing, other processing may be used as long as the audibility of the processed audio A_{signal3} is lower than that of the audio A_{signal2} such that the larger the value of the (Tₙ−T_{audio}) (ms), the farther the sound is felt to be heard.

The return audio processing unit 117 outputs the generated audio A_{signal3} to the return audio presentation device 104 (step S194). The return audio presentation device 104 reproduces and outputs the audio A_{signal3} based on the audio A_{signal2} returned and transmitted from the base R₁ to the base O.

### (Effects)

As described above, in the first embodiment, the server 1 generates a video V_{signal3} from a video V_{signal2} according to a processing mode based on a current time Tₙ and a time T_{video}. In a typical example, the server 1 changes the processing mode based on a value of a difference between the current time Tₙ and the time T_{video}. The server 1 may change the processing mode so as to lower the quality of the video as the value of the difference increases. In this manner, the server 1 can process a video such that the video is inconspicuous when reproduced. In general, in a case where a video projected on a screen or the like is viewed from a certain point X, the video can be clearly visually recognized as long as the distance from the point X to the screen is within a certain range. On the other hand, as the distance increases, the video is small and blurred and is difficult to be visually recognized.

The server 1 generates an audio A_{signal3} from an audio A_{signal2} according to a processing mode based on a current time Tₙ and a time T_{audio}. In a typical example, the server 1 changes the processing mode based on a value of a difference between the current time Tₙ and the time T_{audio}. The server 1 may change the processing mode so as to lower the quality of the audio as the value of the difference increases. In this manner, the server 1 can process an audio such that the audio is hard to be heard when reproduced. In general, in a case where an audio reproduced by a speaker or the like is listened to from the certain point X, the audio can be clearly auditorily recognized at the same time as generation of a sound source as long as the distance from the point X to the speaker (sound source) is within a certain range. On the other hand, as the distance increases, the sound is delayed from the reproduction time of the sound and attenuated, and transmitting and listening to the sound are difficult.

The server 1 can reduce discomfort due to the magnitude of a data transmission delay time while conveying the state of viewers at a physically separated base by performing processing of reproducing viewing as described above on the basis of the current time Tₙ and the time T_{video} or the current time Tₙ and the time T_{audio}.

In this manner, the server 1 can reduce discomfort felt by viewers when a plurality of videos/audios transmitted from a plurality of bases at different times is reproduced.

### Second Embodiment

A second embodiment is an embodiment in which, when a video/audio transmitted from a base O and videos/audios transmitted from a plurality of bases of remote locations other than a base R are reproduced in the base R of a certain remote location, the videos/audios transmitted from the plurality of remote locations other than the base R are processed and reproduced.

Time information used for processing a video/audio is stored in a header extension area of an RTP packet transmitted and received between the base O and each of the bases R₁ to Rₙ. For example, the time information is in an absolute time format (hh:mm:ss.fff format).

Hereinafter, two bases R₁ and R₂ will be mainly described as remote locations, and processing of reproducing a video/audio transmitted from the base O and a video/audio transmitted from the base R₁ in the base R₂ will be described. Description of reception processing of videos/audios returned and transmitted from the base R₁ and the base R₂ in the base O, reception processing and processing of a video/audio transmitted from the base R₂ in the base R₁, and transmission processing of a video/audio obtained by capturing and recording in the base R₂ in the base R₂ to the base O and the base R₁ will be omitted.

Although a video and an audio are described as being transmitted and received in RTP packetization, the present invention is not limited thereto. The video and audio may be processed and managed by the same functional unit/database (DB). Both the video and audio may be stored in one RTP packet and transmitted and received.

### Configuration Example

In the second embodiment, the same components as those of the first embodiment are denoted by the same reference signs, and description thereof will be omitted. In the second embodiment, differences from the first embodiment will be mainly described.

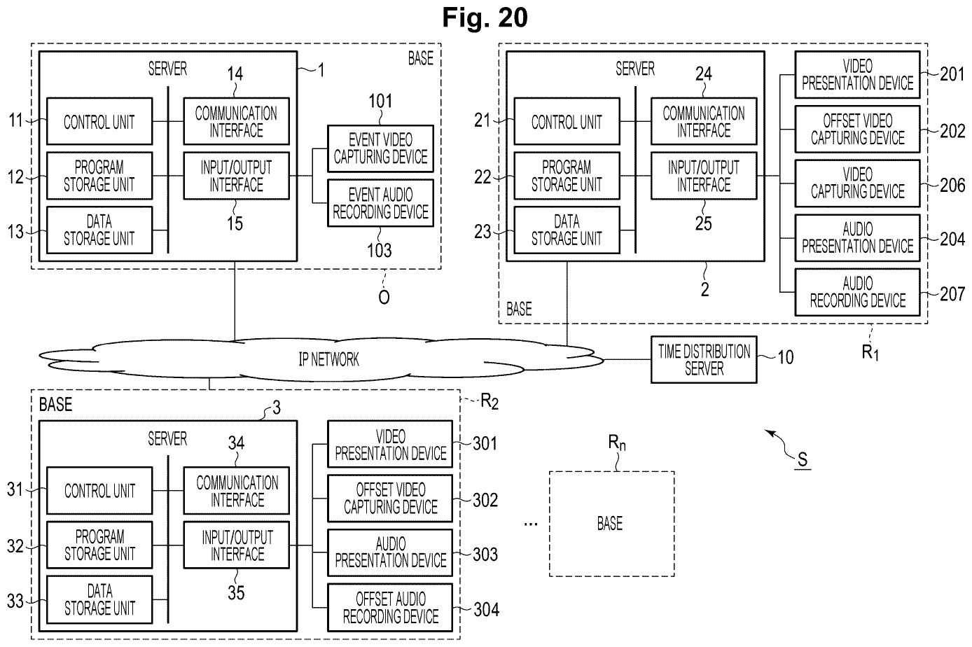

FIG. 20 is a block diagram illustrating an example of a hardware configuration of each electronic device included in a medium processing system S according to the second embodiment.

The medium processing system S includes a plurality of electronic devices included in the base O, a plurality of electronic devices included in each of the bases R₁ to Rₙ, and a time distribution server 10. The electronic devices in each of the bases and the time distribution server 10 can communicate with each other via an IP network.

The base O includes a server 1, an event video capturing device 101, and an event audio recording device 103 as in the first embodiment. The base O is an example of a first base.

As in the first embodiment, the base R₁ includes a server 2, a video presentation device 201, an offset video capturing device 202, and an audio presentation device 204. Unlike the first embodiment, the base R₁ includes a video capturing device 206 and an audio recording device 207. The base R₁ is an example of a second base.

The video capturing device 206 is a device including a camera that captures a video of the base R₁. For example, the video capturing device 206 captures a video of a state of the base R₁ where the video presentation device 201 that reproduces and displays a video transmitted from the base O to the base R₁ is installed. The video capturing device 206 is an example of the video capturing device.

The audio recording device 207 is a device including a microphone that records an audio of the base R₁. For example, the audio recording device 207 records an audio of a state of the base R₁ where the audio presentation device 204 that reproduces and outputs an audio transmitted from the base O to the base R₁ is installed. The audio recording device 207 is an example of the audio recording device.

The base R₂ includes a server 3, a video presentation device 301, an offset video capturing device 302, an audio presentation device 303, and an offset audio recording device 304. The base R₂ is an example of a third base different from the first base and the second base.

The server 3 is an electronic device that controls each of the electronic devices included in the base R₂. The server 3 is an example of a medium processing device.

The video presentation device 301 is a device including a display that reproduces and displays a video transmitted from the base O to the base R₂ and a video transmitted from the base R₁ and each of bases R₃ to Rₙ to the base R₂. The video presentation device 301 is an example of the presentation device.

The offset video capturing device 302 is a device capable of recording a capturing time. The offset video capturing device 302 is a device including a camera installed so as to be able to capture the entire video display area of the video presentation device 301. The offset video capturing device 302 is an example of the video capturing device.

The audio presentation device 303 is a device including a speaker that reproduces and outputs an audio transmitted from the base O to the base R₂ and an audio transmitted from the base R₁ and each of the bases R₃ to Rₙ to the base R₂. The audio presentation device 303 is an example of the presentation device.

The offset audio recording device 304 is a device capable of recording a recording time. The offset audio recording device 304 is a device including a microphone installed so as to be able to record an audio reproduced by the audio presentation device 303. The offset audio recording device 304 is an example of an audio recording device.

A configuration example of the server 3 will be described.

The server 3 includes a control unit 31, a program storage unit 32, a data storage unit 33, a communication interface 34, and an input/output interface 35. The elements included in the server 3 are connected to each other via a bus.

The control unit 31 can be formed similarly to the control unit 11. A processor deploys a ROM or a program stored in the program storage unit 32 in a RAM. The processor executes a program deployed in the RAM, thereby the control unit 31 implements each functional unit described below. The control unit 31 is included in a computer.

The program storage unit 32 can be formed similarly to the program storage unit 12.

The data storage unit 33 can be formed similarly to the data storage unit 13.

The communication interface 34 can be formed similarly to the communication interface 14. The communication interface 34 includes various interfaces that communicatively connect the server 3 to other electronic devices.

The input/output interface 35 can be formed similarly to the input/output interface 15. The input/output interface 35 enables communication between the server 3 and each of the video presentation device 301, the offset video capturing device 302, the audio presentation device 303, and the offset audio recording device 304.

Note that a hardware configuration of the server 3 is not limited to the above-described configuration. The server 3 can appropriately omit and change the above-described components and add a new component.

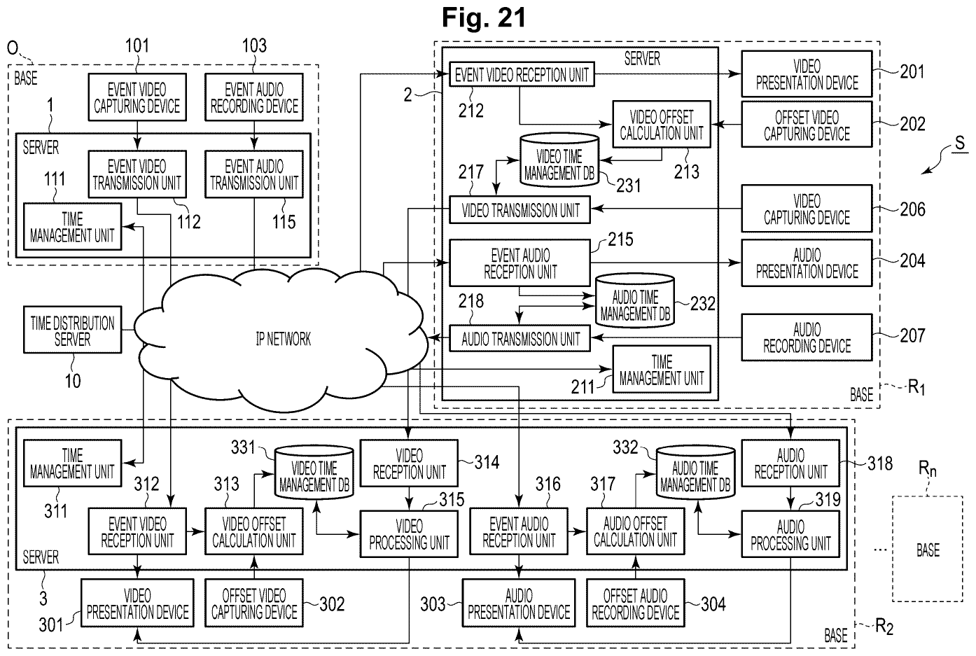

FIG. 21 is a block diagram illustrating an example of a software configuration of each of the electronic devices included in the medium processing system S according to the second embodiment.

As in the first embodiment, the server 1 includes a time management unit 111, an event video transmission unit 112, and an event audio transmission unit 115. Each functional unit is implemented by execution of a program by the control unit 11. It can also be said that each functional unit is included in the control unit 11 or the processor. Each functional unit can be read as the control unit 11 or the processor.

As in the first embodiment, the server 2 includes a time management unit 211, an event video reception unit 212, a video offset calculation unit 213, an event audio reception unit 215, a video time management DB 231, and an audio time management DB 232. Unlike the first embodiment, the server 2 includes a video transmission unit 217 and an audio transmission unit 218. Each functional unit is implemented by execution of a program by the control unit 21. It can also be said that each functional unit is included in the control unit 21 or a processor. Each functional unit can be read as the control unit 21 or the processor. The video time management DB 231 and the audio time management DB 232 are implemented by the data storage unit 23.

The video transmission unit 217 transmits an RTP packet that stores a video V_{signal2} to the server 3 via the IP network. The RTP packet that stores the video V_{signal2} includes a time T_{video} associated with the presentation time t₁ that matches a time t that is an absolute time at which the video V_{signal2} is obtained by capturing. The video V_{signal2} is an example of a second video. An RTP packet is an example of a packet. The time T_{video} is an example of a first time.

The audio transmission unit 218 transmits an RTP packet that stores an audio A_{signal2} to the server 3 via the IP network. The RTP packet that stores the audio A_{signal2} includes a time T_{audio}. The audio A_{signal2} is an example of a second audio. The time T_{audio} is an example of the first time.

The server 3 includes a time management unit 311, an event video reception unit 312, a video offset calculation unit 313, a video reception unit 314, a video processing unit 315, an event audio reception unit 316, an audio offset calculation unit 317, an audio reception unit 318, an audio processing unit 319, a video time management DB 331, and an audio time management DB 332. Each functional unit is implemented by execution of a program by the control unit 31. It can also be said that each functional unit is included in the control unit 31 or a processor. Each functional unit can be read as the control unit 31 or the processor. The video time management DB 331 and the audio time management DB 332 are implemented by the data storage unit 33.

The time management unit 311 performs time synchronization with the time distribution server 10 using a known protocol such as NTP or PTP, and manages the reference system clock. The time management unit 311 manages the same reference system clock as the reference system clock managed by the server 1 and the server 2. The reference system clock managed by the time management unit 311 and the reference system clock managed by the server 1 and the server 2 are time-synchronized.

The event video reception unit 312 receives an RTP packet that stores a video V_{signal1} from the server 1 via the IP network. The event video reception unit 312 outputs the video V_{signal1} to the video presentation device 301. The event video reception unit 312 is an example of a first reception unit. The video V_{signal1} is an example of a first video.

The video offset calculation unit 313 calculates a presentation time t₁ that is an absolute time at which the video V_{signal1} is reproduced by the video presentation device 301 in the base R₂. The video offset calculation unit 313 is an example of a calculation unit. The presentation time t₁ is an example of a third time.

The video reception unit 314 receives an RTP packet that stores a video V_{signal2} from each of servers of the base R₁ and the bases R₃ to Rₙ via the IP network. The video reception unit 314 is an example of a second reception unit.

The video processing unit 315 generates a video V_{signal3} from the video V_{signal2} and outputs the video V_{signal3} to the video presentation device 301. The video processing unit 315 is an example of a processing unit. The video V_{signal3} is an example of a third video.

The event audio reception unit 316 receives an RTP packet that stores an audio A_{signal1} from the server 1 via the IP network. The event audio reception unit 316 outputs an audio A_{signal1} to the audio presentation device 303. The event audio reception unit 316 is an example of the first reception unit. The audio A_{signal1} is an example of a first audio.

The audio offset calculation unit 317 calculates a presentation time t₂ that is an absolute time at which the audio A_{signal1} is reproduced by the audio presentation device 303 in the base R₂. The audio offset calculation unit 317 is an example of a calculation unit. The presentation time t₂ is an example of the third time.

The audio reception unit 318 receives an RTP packet that stores an audio A_{signal2} from each of the servers of the base R₁ and the bases R₃ to Rₙ via the IP network. The audio reception unit 318 is an example of the second reception unit.

The audio processing unit 319 generates an audio A_{signal3} from the audio A_{signal2} and outputs the audio A_{signal3} to the audio presentation device 303. The audio processing unit 319 is an example of a processing unit. The audio A_{signal3} is an example of a third audio.

The video time management DB 331 may have a data structure similar to that of the video time management DB 231. The video time management DB 331 is a DB that stores times T_{video} acquired from the video offset calculation unit 313 and presentation times t₁ in association with each other. The video time management DB 331 is an example of a storage unit.

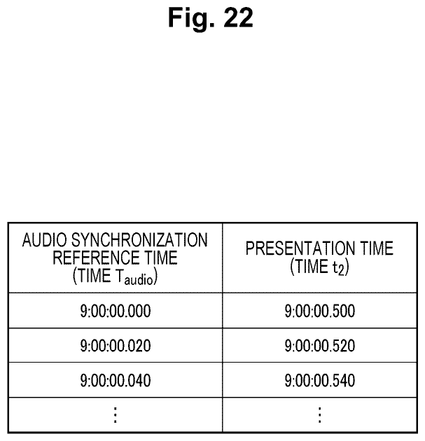

FIG. 22 is a diagram illustrating an example of a data structure of the audio time management DB 332 included in the server 3 of the base R₂ according to the second embodiment.

The audio time management DB 332 is a DB that stores times T_{audio} acquired from the audio offset calculation unit 317 and presentation times t₂ in association with each other. The audio time management DB 332 is an example of a storage unit.

The audio time management DB 332 includes an audio synchronization reference time column and a presentation time column. The audio synchronization reference time column stores the times T_{audio}. The presentation time column stores the presentation times t₂.

### Operation Example

Hereinafter, operation of the base O, the base R₁, the base R₂ will be described as an example.

### (1) Process and Reproduce Video

Video processing of the server 1 in the base O will be described.

The event video transmission unit 112 transmits an RTP packet that stores a video V_{signal1} to each of servers of the bases R₁ to Rₙ via the IP network. A time T_{video} is provided to the RTP packet that stores the video V_{signal1}. The time T_{video} is time information for processing a video in each of bases (R₁, R₂, . . . , Rₙ) other than the base O. The processing of the event video transmission unit 112 may be similar to the processing described in the first embodiment using FIG. 7, and description thereof will be omitted.

Video processing of the server 2 in the base R₁ will be described.

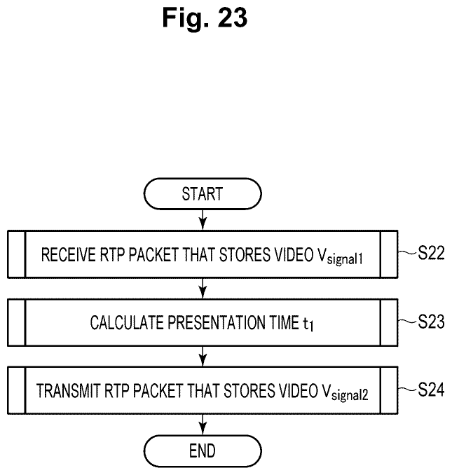

FIG. 23 is a flowchart illustrating a video processing procedure and processing content of the server 2 in the base R₁ according to the second embodiment.

The event video reception unit 212 receives an RTP packet that stores a video V_{signal1} from the server 1 via the IP network (step S22).

A typical example of the processing of the event video reception unit 212 in step S22 may be similar to the processing described in the first embodiment using FIG. 8, and description thereof will be omitted.

The video offset calculation unit 213 calculates a presentation time t₁ at which the video V_{signal1} is reproduced by the video presentation device 201 (step S23).

A typical example of the processing of the video offset calculation unit 213 in step S23 may be similar to the processing described in the first embodiment using FIG. 9, and description thereof will be omitted.

The video transmission unit 217 transmits an RTP packet that stores a video V_{signal2} to the server 3 via the IP network (step S24).

A typical example of the processing of the video transmission unit 217 in step S24 may be similar to the processing of the return video transmission unit 214 described in the first embodiment using FIG. 10.

Description of the processing of the video transmission unit 217 will be omitted by the notation of the “return video capturing device 203” and the “return video transmission unit 214” being replaced with the “video capturing device 206” and the “video transmission unit 217” in the description using FIG. 10.

Video processing of the server 3 in the base R₂ will be described.

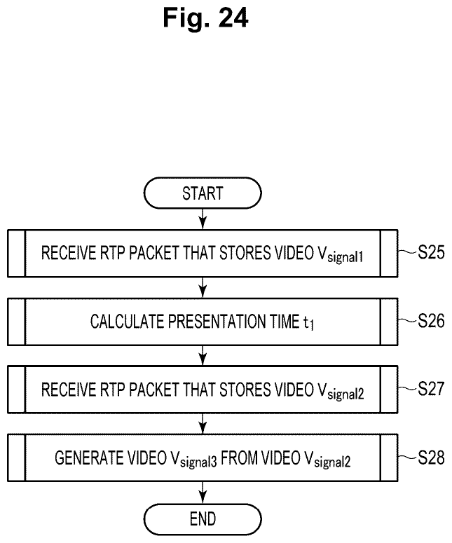

FIG. 24 is a flowchart illustrating a video processing procedure and processing content of the server 3 in the base R₂ according to the second embodiment.

The event video reception unit 312 receives an RTP packet that stores a video V_{signal1} from the server 1 via the IP network (step S25).

A typical example of the processing of the event video reception unit 312 in step S25 may be similar to the processing of the event video reception unit 212 described in the first embodiment using FIG. 8.

Description of the processing of the event video reception unit 312 will be omitted by the notation of the “video presentation device 201”, the “event video reception unit 212”, and the “video offset calculation unit 213”, being replaced with the “video presentation device 301”, the “event video reception unit 312”, and the “video offset calculation unit 313” in the description using FIG. 8.

The video offset calculation unit 313 calculates a presentation time t₁ at which the video V_{signal1} is reproduced by the video presentation device 301 (step S26).

A typical example of the processing of the video offset calculation unit 313 in step S26 may be similar to the processing of the video offset calculation unit 213 described in the first embodiment using FIG. 9.

Description of the processing of the video offset calculation unit 313 will be omitted being the notation of the “offset video capturing device 202”, the “event video reception unit 212”, the “video offset calculation unit 213”, and the “video time management DB 231” being replaced with the “offset video capturing device 302”, the “event video reception unit 312”, the “video offset calculation unit 313”, and the “video time management DB 331” in the description using FIG. 9.

The video reception unit 314 receives an RTP packet that stores a video V_{signal2} from the server 2 of the base R₁ via the IP network (step S27).

A typical example of the processing of the video reception unit 314 in step S27 may be similar to the processing of the return video reception unit 113 described in the first embodiment using FIG. 11.

Description of the processing of the video reception unit 314 will be omitted by the notation of the “return video reception unit 113”, the “return video processing unit 114” and the “return video transmission unit 214” being replaced with the “video transmission unit 217”, the “video reception unit 314”, and the “video processing unit 315” in the description using FIG. 11.

The video processing unit 315 generates a video V_{signal3} from the video V_{signal2} according to a processing mode based on a current time Tₙ and the presentation time t₁ associated with reception of the RTP packet that stores the video V_{signal2} by the return video reception unit 314. The video processing unit 315 outputs the video V_{signal3} to the video presentation device 301 (step S28).

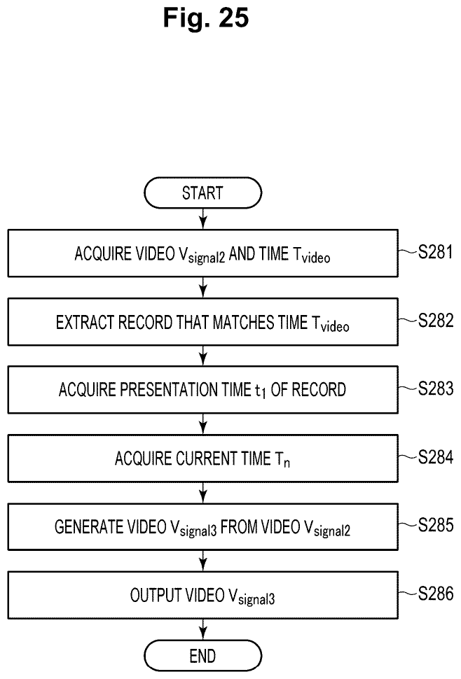

FIG. 25 is a flowchart illustrating a process processing procedure and processing content of a video V_{signal2} of the server 3 in the base R₂ according to the second embodiment. FIG. 25 illustrates the typical example of the processing of step S28 of the server 3.

The video processing unit 315 acquires a video V_{signal2} and a time T_{video} from the video reception unit 314 (step S281).

The video processing unit 315 refers to the video time management DB 331 and extracts a record having a video synchronization reference time that matches the acquired time T_{video} (step S282).

The video processing unit 315 refers to the video time management DB 331 and acquires a presentation time t₁ in the presentation time column of the extracted record (step S283).

The video processing unit 315 acquires a current time Tₙ from the reference system clock managed by the time management unit 311 (step S284). The current time Tₙ is a time associated with reception of an RTP packet that stores the video V_{signal2} by the video reception unit 314. The current time Tₙ can also be referred to as a reception time of the RTP packet that stores the video V_{signal2}. The current time Tₙ can also be referred to as a reproduction time of a video V_{signal3} generated on the basis of the video V_{signal2}. The current time Tₙ associated with the reception of the RTP packet that stores the video V_{signal2} is an example of a second time.

The video processing unit 315 generates the video V_{signal3} from the acquired video V_{signal2} according to a processing mode based on the acquired current time Tₙ and presentation time t₁ (step S285). In step S285, for example, the video processing unit 315 determines the processing mode of the video V_{signal2} on the basis of a value of a difference between the current time Tₙ and presentation time t₁, that is, a value of (Tₙ−t₁) (ms). The video processing unit 315 changes the processing mode of the video V_{signal2} on the basis of the value of the (Tₙ−t₁). The video processing unit 315 changes the processing mode so as to lower the quality of the video as the value of the difference increases. The processing mode may include both performing processing on the video V_{signal2} and not performing processing on the video V_{signal2}. The processing mode includes a degree of processing on the video V_{signal2}.

The video processing unit 315 performs processing of reducing the visibility when reproduction is performed by the video presentation device 301. When the value of the (Tₙ−t₁) is so small that viewers do not feel discomfort by reproduction of the video V_{signal3} by the video presentation device 301, the video processing unit 315 does not perform processing on the video V_{signal2}. Furthermore, even in a case where the value of the (Tₙ−t₁) is too large, the video processing unit 315 performs processing on the video V_{signal2} so that the video does not become completely visually unrecognizable. For example, a case of processing of changing the display size of the video V_{signal2} will be described. Assuming that a horizontal pixel of the video V_{signal2} is w and a vertical pixel is h, a horizontal pixel w′ and a vertical pixel h′ of the video V_{signal3} generated according to the processing mode are as follows.
(1) When 0 ms≤Tₙ−t₁≤300 ms,
   w′=w, h′=h
(2) When 300 ms<Tₙ−t₁≤500 ms,
   w′={−( 1/400)(Tₙ−t₁)+7/4}*w, h′={−( 1/400)(Tₙ−t₁)+7/4}*h
(3) When 500 ms<Tₙ−t₁,
   w′=0.5*w, h′=0.5*h

The processing is not limited to the above as the change of the quality of the video, and may be, in addition to the above display size change, blurring an image by a Gaussian filter, lowering the luminance of an image, or the like. The processing may use other processing as long as the processed video V_{signal3} has lower visibility than the video V_{signal2}.

The video processing unit 315 outputs the generated video V_{signal3} to the video presentation device 301 (step S286). The video presentation device 301 reproduces and displays the video V_{signal3} based on the video V_{signal2} returned and transmitted from the base R₁ and each of the bases R₃ to Rₙ to the base R₂.

### (2) Process and Reproduce Audio

Audio processing of the server 1 in the base O will be described.

The event audio transmission unit 115 transmits an RTP packet that stores an audio A_{signal1} to each of the servers of the bases R₁ to Rₙ via the IP network. The time T_{audio} is provided to the RTP packet that stores the audio A_{signal1}. The time T_{audio} is time information for processing an audio in each of the bases (R₁, R₂, . . . , Rₙ) other than the base O. The processing of the event audio transmission unit 115 may be similar to the processing described in the first embodiment using FIG. 15, and description thereof will be omitted.

Audio processing of the server 2 in the base R₁ will be described.

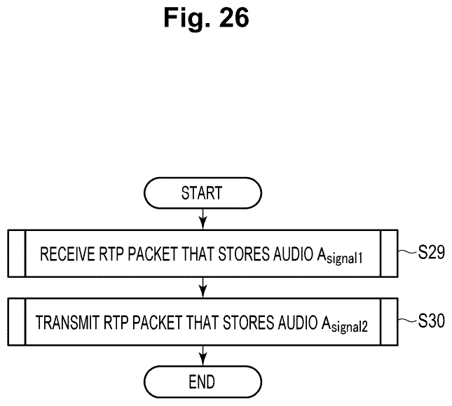

FIG. 26 is a flowchart illustrating an audio processing procedure and processing content of the server 2 in the base R₁ according to the second embodiment.

The event audio reception unit 215 receives an RTP packet that stores an audio A_{signal1} from the server 1 via the IP network (step S29).

A typical example of the processing of the event audio reception unit 215 in step S29 may be similar to the processing described in the first embodiment using FIG. 16, and description thereof will be omitted.

The audio transmission unit 218 transmits an RTP packet that stores an audio A_{signal2} to the server 3 via the IP network (step S30).

A typical example of the processing of the audio transmission unit 218 in step S30 may be similar to the processing of the return audio transmission unit 216 described in the first embodiment using FIG. 17.

Description of the processing of the audio transmission unit 218 will be omitted by the notation of the “return audio recording device 205” and the “return audio transmission unit 216” being replaced with the “audio recording device 207” and the “audio transmission unit 218” in the description using FIG. 17.

Audio processing of the server 3 in the base R₂ will be described.

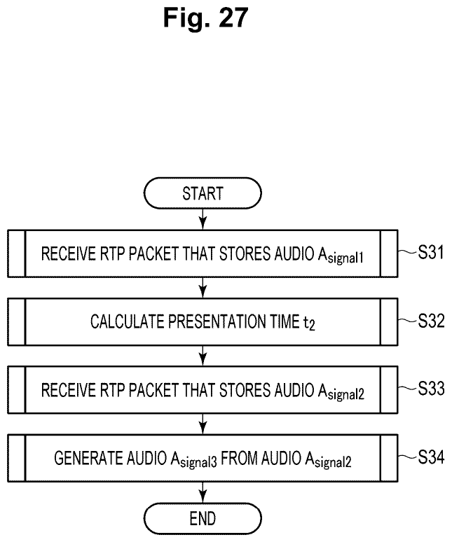

FIG. 27 is a flowchart illustrating an audio processing procedure and processing content of the server 3 in the base R₂ according to the second embodiment. The event audio reception unit 316 receives an RTP packet that stores an audio A_{signal1} from the server 1 via the IP network (step S31). A typical example of processing of step S31 will be described below.

The audio offset calculation unit 317 calculates a presentation time t₂ at which the audio A_{signal1} is reproduced by the audio presentation device 303 (step S32). A typical example of processing of step S32 will be described below.

The audio reception unit 318 receives an RTP packet that stores an audio A_{signal2} from the server 2 of the base R₁ via the IP network (step S33).

A typical example of the processing of the audio reception unit 318 in step S33 may be similar to the processing of the return audio reception unit 116 described in the first embodiment using FIG. 18.

Description of the processing of the audio reception unit 318 will be omitted by the notation of the “return audio reception unit 116”, the “return audio processing unit 117”, and the “return audio transmission unit 216” being replaced with the “audio reception unit 318”, the “audio processing unit 319”, and the “audio transmission unit 218” in the description using FIG. 18.

The audio processing unit 319 generates an audio A_{signal3} from the audio A_{signal2} according to a processing mode based on a current time Tₙ and the presentation time t₂ associated with reception of the RTP packet that stores the audio A_{signal2} by the audio reception unit 318. The audio processing unit 319 outputs the audio A_{signal3} to the audio presentation device 303 (step S34). A typical example of processing of step S34 will be described below.

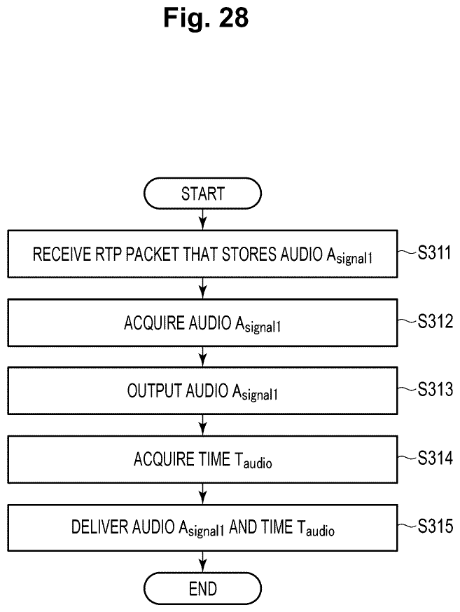

FIG. 28 is a flowchart illustrating a reception processing procedure and processing content of an RTP packet that stores an audio A_{signal1} of the server 3 in the base R₂ according to the second embodiment. FIG. 28 illustrates the typical example of the processing of step S31 of the server 3.

The event audio reception unit 316 receives an RTP packet that stores an audio A_{signal1} sent out from the event audio transmission unit 115 via the IP network (step S311).

The event audio reception unit 316 acquires the audio A_{signal1} stored in the received RTP packet that stores the audio A_{signal1} (step S312).

The event audio reception unit 316 outputs the acquired audio A_{signal1} to the audio presentation device 303 (step S313). The audio presentation device 303 reproduces and outputs the audio A_{signal1}.

The event audio reception unit 316 acquires a time T_{audio} stored in the header extension area of the received RTP packet that stores the audio A_{signal1} (step S314).

The event audio reception unit 316 delivers the acquired audio A_{signal1} and the time T_{audio} to the audio offset calculation unit 317 (step S315).

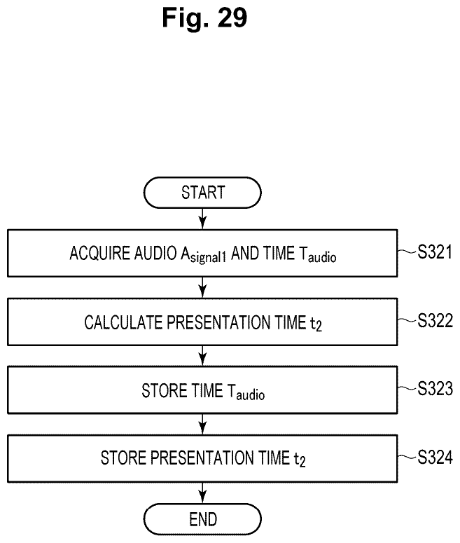

FIG. 29 is a flowchart illustrating a calculation processing procedure and processing content of a presentation time t₂ of the server 3 in the base R₂ according to the second embodiment. FIG. 29 illustrates the typical example of the processing of step S32 of the server 3.

The audio offset calculation unit 317 acquires an audio A_{signal1} and a time T_{audio} from the event audio reception unit 316 (step S321).

The audio offset calculation unit 317 calculates a presentation time t₂ on the basis of the acquired audio A_{signal1} and an audio input from the offset audio recording device 304 (step S322). The audio acquired by the offset audio recording device 304 includes the audio A_{signal1} reproduced by the audio presentation device 303 and an audio generated at the base R₂ (cheers of the audience at the base R₂ and the like). In step S322, for example, the audio offset calculation unit 317 separates the two audios by a known audio analysis technology. The audio offset calculation unit 317 acquires the presentation time t₂ that is an absolute time at which the audio A_{signal1} is reproduced by the audio presentation device 303 by separating the audios.

The audio offset calculation unit 317 stores the acquired time T_{audio} in the audio synchronization reference time column of the audio time management DB 332 (step S323).

The audio offset calculation unit 317 stores the acquired presentation time t₂ in the presentation time column of the audio time management DB 332 (step S324).

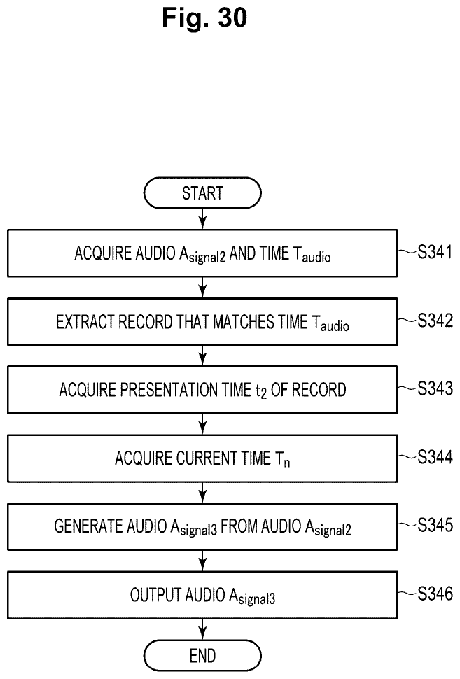

FIG. 30 is a flowchart illustrating a process processing procedure and processing content of an audio A_{signal2} Of the server 3 in the base R₂ according to the second embodiment. FIG. 30 illustrates the typical example of the processing of step S34 of the server 3.

The audio processing unit 319 acquires an audio A_{signal2} and a time T_{audio} from the audio reception unit 318 (step S341).

The audio processing unit 319 refers to the audio time management DB 332 and extracts a record having the audio synchronization reference time that matches the acquired time T_{audio} (step S342).

The audio processing unit 319 refers to the audio time management DB 332 and acquires a presentation time t₂ in the presentation time column of the extracted record (step S343).

The audio processing unit 319 acquires a current time Tₙ from the reference system clock managed by the time management unit 311 (step S344). The current time Tₙ is a time associated with reception of an RTP packet that stores an audio A_{signal2} by the audio reception unit 318. The current time Tₙ can also be referred to as a reception time of the RTP packet that stores the audio A_{signal2}. The current time Tₙ can also be referred to as a reproduction time of an audio A_{signal3} generated on the basis of the audio A_{signal2}. The current time Tₙ associated with the reception of the RTP packet that stores the audio A_{signal2} is an example of the second time.

The audio processing unit 319 generates the audio A_{signal3} from the acquired audio A_{signal2} according to a processing mode based on the acquired current time Tₙ and presentation time t₂ (step S345). In step S345, for example, the audio processing unit 319 determines the processing mode of the audio A_{signal2} on the basis of a value of a difference between the current time Tₙ and presentation time t₂, that is, a value of (Tₙ−t₂) (ms). The audio processing unit 319 changes the processing mode of the audio A_{signal2} on the basis of the value of the (Tₙ−t₂). The audio processing unit 319 changes the processing mode so as to lower the quality of the audio as the value of the difference increases. The processing mode may include both performing processing on the audio A_{signal2} and not performing processing on the audio A_{signal2}. The processing mode includes a degree of processing on the audio A_{signal2}.

The audio processing unit 319 performs processing of reducing the audibility when reproduction is performed by the audio presentation device 303. When the value of the (Tₙ−t₂) is so small that viewers do not feel discomfort by reproduction of the audio A_{signal2} by the audio presentation device 303, the audio processing unit 319 does not perform processing on the audio A_{signal2}. Furthermore, even in a case where the value of the (Tₙ−t₂) is too large, the audio processing unit 319 performs processing on the audio A_{signal2} so that the audio does not become completely auditorily unrecognizable. For example, a case of processing of changing the strength of the audio A_{signal2} will be described. Assuming that the strength of the audio A_{signal2} is s, the strength s′ of the audio A_{signal3} generated according to the processing mode is as follows.
(1) When 0 ms≤Tₙ−t₂≤100 ms, s′=s
(2) When 100 ms<Tₙ−t₂≤300 ms, s′={−( 1/400)(Tₙ−t₂)+5/4}*s
(3) When 300 ms<Tₙ−t₂, s′=0.5*s

The processing is not limited to the above as the change of the quality of the audio, and may be, in addition to the change of the strength of the sound, gradual reduction of a component of a high frequency by low-pass filtering in which a threshold is smaller as the value of the (Tₙ−t₂) (ms) is larger. In the processing, other processing may be used as long as the audibility of the processed audio A_{signal3} is lower than that of the audio A_{signal2} such that the larger the value of the (Tₙ−t₂) (ms), the farther the sound is felt to be heard.

The audio processing unit 319 outputs the generated audio A_{signal3} to the audio presentation device 303 (step S346). The audio presentation device 303 reproduces and outputs the audio A_{signal3} based on the audio A_{signal2} returned and transmitted from the base R₁ and each of the bases R₃ to Rₙ to the base R₂.

### (Effects)

As described above, in the second embodiment, the server 3 generates a video V_{signal3} from a video V_{signal2} according to a processing mode based on a current time Tₙ and a presentation time t₁. In a typical example, the server 3 changes the processing mode based on a value of a difference between the current time Tₙ and the presentation time t₁. The server 3 may change the processing mode so as to lower the quality of the video as the value of the difference increases. In this manner, the server 3 can process a video such that the video is inconspicuous when reproduced. In general, in a case where a video projected on a screen or the like is viewed from a certain point X, the video can be clearly visually recognized as long as the distance from the point X to the screen is within a certain range. On the other hand, as the distance increases, the video is small and blurred and is difficult to be visually recognized.

The server 3 generates an audio A_{signal3} from an audio A_{signal2} according to a processing mode based on a current time Tₙ and a presentation time t₂. In a typical example, the server 3 changes the processing mode based on a value of a difference between the current time Tₙ and the presentation time t₂. The server 3 may change the processing mode so as to lower the quality of the audio as the value of the difference increases. In this manner, the server 3 can process an audio such that the audio is hard to be heard when reproduced. In general, in a case where an audio reproduced by a speaker or the like is listened to from the certain point X, the audio can be clearly auditorily recognized at the same time as generation of a sound source as long as the distance from the point X to the speaker (sound source) is within a certain range. On the other hand, as the distance increases, the sound is delayed from the reproduction time of the sound and attenuated, and transmitting and listening to the sound are difficult.

The server 3 can reduce discomfort due to the magnitude of a data transmission delay time while conveying the state of viewers at a physically separated base by performing processing of reproducing viewing as described above on the basis of the current time Tₙ and the presentation time t₂ or the current time Tₙ and the presentation time t₁.

In this manner, the server 3 can reduce discomfort felt by viewers when a plurality of videos/audios transmitted from a plurality of bases at different times is reproduced.

### Other Embodiments

The medium processing device may be implemented by one device as described in the above examples, or may be implemented by a plurality of devices in which functions are distributed.

The program may be transferred in a state of being stored in an electronic device, or may be transferred in a state of not being stored in an electronic device. In the latter case, the program may be transferred via a network or may be transferred in a state of being recorded in a recording medium. The recording medium is a non-transitory tangible medium. The recording medium is a computer-readable medium. The recording medium is only required to be a medium that can store a program and can be read by a computer, such as a CD-ROM or a memory card, and any form can be used.

Although the embodiments of the present invention have been described in detail above, the above description is merely an example of the present invention in all respects. It goes without saying that various improvements and modifications can be made without departing from the scope of the present invention. That is, in carrying out the present invention, a specific configuration according to the embodiment may be appropriately employed.

In short, the present invention is not limited to the above-described embodiments without any change, and can be embodied by modifying the constituents without departing from the concept of the invention at the implementation stage. Various inventions can be implemented by appropriately combining a plurality of the constituents disclosed in the above-described embodiments. For example, some constituents may be omitted from all the constituents described in the embodiments. The constituents in different embodiments may be appropriately combined.

### REFERENCE SIGNS LIST

1 Server
2 Server
3 Server
10 Time distribution server
11 Control unit
12 Program storage unit
13 Data storage unit
14 Communication interface
15 Input/output interface
21 Control unit
22 Program storage unit
23 Data storage unit
24 Communication interface
25 Input/output interface
31 Control unit
32 Program storage unit
33 Data storage unit
34 Communication interface
35 Input/output interface
101 Event video capturing device
102 Return video presentation device
103 Event audio recording device
104 Return audio presentation device
111 Time management unit
112 Event video transmission unit
113 Return video reception unit
114 Return video processing unit
115 Event audio transmission unit
116 Return audio reception unit
117 Return audio processing unit
201 Video presentation device
202 Offset video capturing device
203 Return video capturing device
204 Audio presentation device
205 Return audio recording device
206 Video capturing device
207 Audio recording device
211 Time management unit
212 Event video reception unit
213 Video offset calculation unit
214 Return video transmission unit
215 Event audio reception unit
216 Return audio transmission unit
217 Video transmission unit
218 Audio transmission unit
231 Video time management DB
232 Audio time management DB
301 Video presentation device
302 Offset video capturing device
303 Audio presentation device
304 Offset audio recording device
311 Time management unit
312 Event video reception unit
313 Video offset calculation unit
314 Video reception unit
315 Video processing unit
316 Event audio reception unit
317 Audio offset calculation unit
318 Audio reception unit
319 Audio processing unit
331 Video time management DB
332 Audio time management DB
O Base
R₁ to Rₙ Base
S Medium processing system

1. A medium processing device of a first base, comprising:
a receiver that receives a packet that stores a second medium acquired in a second base at a time when a first medium acquired at a first time in the first base is reproduced in the second base; and
processing circuitry that generates a third medium from the second medium according to a processing mode based on a second time associated with reception of a packet that stores the second medium and the first time, and outputs the third medium to a presentation device.

2. The medium processing device according to claim 1, wherein:
the processing circuitry changes the processing mode based on a value of a difference between the second time and the first time.

3. A medium processing device of a third base different from a first base and a second base, the medium processing device comprising:
a first receiver that receives a packet that stores a first medium acquired at a first time at the first base, and outputs the first medium to a presentation device;
a second receiver that receives a packet that stores a second medium acquired in the second base at a time at which the first medium is reproduced in the second base; and
processing circuitry that generates a third medium from the second medium according to a processing mode based on a second time associated with reception of a packet that stores the second medium and a third time at which the first medium is reproduced by the presentation device, and outputs the third medium to the presentation device.

4. The medium processing device according to claim 3, wherein the processing circuitry changes the processing mode based on a value of a difference between the second time and the third time.

5. The medium processing device according to claim 2, wherein the processing circuitry changes the processing mode so as to lower quality of a medium as a value of the difference increases.

6. A medium processing method, comprising:
receiving a packet that stores a second medium acquired in a second base at a time at which a first medium acquired at a first time in a first base is reproduced in the second base;
generating a third medium from the second medium according to a processing mode based on a second time associated with reception of a packet that stores the second medium and the first time; and
outputting the third medium.

7. (canceled)

8. A non-transitory computer readable medium storing a medium processing program for causing a computer to perform the method of claim 6.
